(19) United States
(12) Patent Application Publication
(10) Pub. No.: US 2011/0200685 A1
(43) Pub. Date: Aug. 18, 2011

(54) Methods and compositions for the reduction of pathogenic microorganisms from meat and poultry carcasses, trim and offal

(76) Inventors: Michael S. Harvey, Modesto, CA (US); Jonathan N. Howarth, Modesto, CA (US); Courtney E. Mesrobian, Modesto, CA (US)

(21) Appl. No.: 12/925,301

(22) Filed: Oct. 19, 2010

Related U.S. Application Data
(63) Continuation-in-part of application No. 12/658,916, filed on Feb. 16, 2010.

(51) Int. Cl. A01N 59/00; A01P 1/00

(52) U.S. Cl. 424/661; 424/723

(57) ABSTRACT

The invention includes a method of preparing hypochlorite-activated solutions of hypobromous acid and/or hypobromite ion. The method includes the steps of mixing a solution of a source of bromide ion with a solution of a source of hypochlorite ion to activate the bromide ion, allowing sufficient time to maximize the activation of the bromide ion, and storing the solution before use. The invention also includes a method of using the solution to wash meat and poultry carcasses, trim, and offal to reduce pathogenic microorganisms. The solutions may also be used to reduce pathogenic microorganisms in industrial cooling water and on food contact hard surfaces and equipment. The solutions may be stored for up to about three hours before use and are stable for that period of time.

### CROSS-REFERENCE TO RELATED APPLICATION

Pursuant to 35 U.S.C. §120, this application is a continuation-in-part of and claims priority to co-pending U.S. patent application Ser. No. 12/658,916 filed on Feb. 16, 2010, the entire disclosure of which is incorporated herein by reference.

### BACKGROUND OF THE INVENTION

1. Field of the Invention

The invention relates to methods and compositions for reducing pathogenic microorganisms on meat and poultry carcasses, trim, and offal, in industrial cooling water, and on food contact hard surfaces and equipment.

2. Description of the Related Art

The use of sodium bromide in conjunction with a source of sodium hypochlorite bleach to generate a hypobromous acid biocide for the treatment of cooling water has been a standard practice for decades. There are three existing methods for making biocidal solutions of hypobromous acid and/or hypobromite ion for the treatment of cooling water.

First, the major supplier of sodium bromide (BWA Additives) recommends a process of directing makeup water, sodium bromide, and sodium hypochlorite solutions to a residence tank. Water Front Product Information. LiquiBrom®3800—LiquiBrom 4000—LiquiBrom 4300—LiquiBrom 4600. Cost Effective Bromine Source for Microbiological Control in Industrial Water Treatment. Published by BWA Water Additives, 2006. Upon activation or oxidation of the bromide (Br⁻) ion to hypobromous acid and/or hypobromite ion (HOBr/OBr⁻), the mixture is immediately introduced to the cooling water to be treated. This reference states that the maximum concentration of activated HOBr/OBr⁻ that can be achieved is 2500 ppm expressed as Cl₂ (or 5625 ppm expressed as Br₂). This reference teaches that any attempt to increase the concentration of activated HOBr/OBr⁻ to more than 2500 ppm expressed as Cl₂ (or 5625 ppm expressed as Br₂) would simply be a waste of bromide ion.

The second method, disclosed in U.S. Pat. No. 4,451,376, involves feeding sodium bromide and sodium hypochlorite solutions to a common tee before directing the mixture into the recirculating cooling water. Both the first and second methods require the immediate addition of the activated solution to the cooling water to be treated based on the widely-held belief that the activated solution is unstable and quickly loses activity due to HOBr/OBr⁻ decomposition.

The third method, described in U.S. Pat. No. 5,208,057, requires introducing sodium bromide and sodium hypochlorite independently to the cooling water so that the activation of Br⁻ ion by hypochlorite occurs over time, under more dilute conditions in-situ. The '057 patent discloses the use of the in-situ method of activating Br⁻ ion to HOBr for disinfection action during the butchering and processing of fowl. The '057 patent describes the introduction of a source of Br⁻ ion to chicken chill or scald tank water followed by the separate addition of an oxidizing agent for activation.

All three methods generally employ a molar excess of sodium hypochlorite over sodium bromide because it has been assumed that excess hypochlorite re-oxidizes bromide ion into HOBr/OBr⁻. The activated HOBr/OBr⁻ forms in the bulk cooling water. The amount of each activated species formed is dependent on the pH of the bulk water.

In the preparation of biocides, it is very important that the chemical reactants be utilized as efficiently as possible in order to conserve raw material costs. The problem with the existing methods is that they require the biocide to be prepared immediately before it is added to the water to be treated, rather than being prepared in advance and stored, because of the presumed instability of the activated solution. This results in waste of the reactants and inefficiency in preparation, which increases the cost of the biocide program.

The prior art does not disclose the efficiency of the various methods employed for treatment of industrial cooling water with respect to the percent conversion of sodium bromide into HOBr/OBr⁻ ion and the percent utilization of sodium hypochlorite. The prior art also does not teach that sufficient time be allowed for the hypochlorite source to activate Br⁻ ion and maximize the conversion of Br⁻ into HOBr/OBr⁻. Further, the prior art does not disclose the rate at which Br⁻ ion is activated under the different conditions.

Thus, there is a need for a method for preparing a stable hypochlorite-activated solution of HOBr/OBr⁻ ion that efficiently converts Br⁻ ion and significantly utilizes NaOCl, and results in a product that can be stored for use throughout a working day.

### SUMMARY OF THE CLAIMED INVENTION

An embodiment of the invention overcomes one or more of the problems with the known prior art by providing a method of preparing hypochlorite-activated solutions of HOBr/OBr⁻ ion that are efficient to prepare, may be stored, and can be used for the reduction of pathogenic microorganisms in water used to wash meat and poultry carcasses, trim, and offal; industrial cooling water; and water used to sanitize food contact hard surfaces and equipment. In one embodiment, the method includes mixing a solution of a source of bromide ion with a solution of a source of hypochlorite ion to activate the bromide ion and to form a solution selected from the group consisting of hypobromous acid, hypobromite ion, and a mixture of both hypobromous acid and hypobromite ion; allowing sufficient time to maximize the activation of the bromide ion into the solution selected from the group consisting of hypobromous acid, hypobromite ion, and a mixture of both hypobromous acid and hypobromite ion; storing the solution for subsequent use; and introducing the stored solution to water used to wash meat and poultry carcasses, trim, and offal, to industrial cooling water, or to water used to sanitize food contact hard surfaces and equipment, for the reduction of pathogenic microorganisms. The resulting solutions can be stored for up to about three hours before being used.

### BRIEF DESCRIPTION OF THE DRAWINGS

FIG. 1 is a schematic representation of a system used to continuously prepare a solution of hypobromous acid (HOBr) in a controlled manner according to the method of the invention.

FIG. 2 is a graph showing the decay of HOBr from 1,3-dibromo-5,5-dimethylhydantoin (DBDMH) compared to HOBr from NaOCl-activated HBr solution (600 ppm as bromine).

FIG. 3 is a graph showing the stability profile of hypobromous acid as bromine.

FIG. 4 is a graph showing the pH over time of HOBr solutions.

FIG. 5 is a graph showing the bromine concentration over time using the residence time method (1:1 NaBr:NaOCl mole ratio, 1000 ppm as Br₂).

FIG. 6 is a graph showing the percent bromide ion activated over time using the residence time method (1:1 NaBr:NaOCl mole ratio, 1000 ppm as Br₂).

FIG. 7 is a graph showing the concentration of bromine over time using the residence time method (1:1 NaBr:NaOCl mole ratio, 10,000 ppm as Br₂).

FIG. 8 is a graph showing the percent conversion of Br⁻ ion over time using the residence time method (1:1 NaBr:NaOCl mole ratio, 10,000 ppm as Br₂).

FIG. 9 is a graph showing the stability of bromine (HOBr/OBr⁻) ion and percent Br⁻ ion converted in the activated solution (1:1 mole ratio NaBr:NaOCl, no additional water).

FIG. 10 is a graph showing the cooling water stability profile of HOBr/OBr⁻ generated (1:1 NaBr:NaOCl mole ratio without additional water).

FIG. 11 is a graph showing the HOBr/OBr⁻ ion generation and stability profile in cooling water for 1:2 NaBr:NaOCl mole ratio showing depletion of excess chlorine.

### DETAILED DESCRIPTION OF THE INVENTION

### I. Analytical Methods Used

In the examples set forth below, references are made to an iodometric titration, a N,N-diethyl-p-phenylenediamine (DPD) Total Halogen Colorimetric Method and a DPD Differentiation Colorimetric Method (also known as the Palin Modification). These methods were used to quantify and/or differentiate halogen levels for the microbiology and storage stability studies, which are now presented. Each method is described in detail below.

A. Iodometric Titration Method

The iodometric titration is a technique that allows for the determination of the total halogen present in any given system and is usually the method of choice when concentrated halogen solutions are prepared. This technique does not allow for the differentiation between the halogens e.g. how much is present as bromine and how much is present as chlorine. Therefore, the halogen levels determined by the iodometric method are usually expressed in terms of “as chlorine” or “as bromine” even though the system may contain a mixture of both bromine and chlorine. A typical iodometric titration is performed as follows:

A sample of the halogen-containing solution is accurately weighed (4 decimal places) to a beaker, then deionized water (DI) or reverse osmosis (RO) water is added to the beaker. Using a magnetic stir bar to ensure appropriate mixing, add approximately 5 ml of 80% acetic acid and approximately 1 g potassium iodide crystals to the beaker. Mix the solution and allow the potassium iodide crystals to dissolve. The solution will turn a dark yellow/red color as the bromine or chlorine or both, oxidize the iodide ion to liberate iodine. Under acidic conditions, aqueous halogen-containing solutions quantitatively liberate iodine from excess potassium iodide. The liberated iodine is titrated with a standard solution of 0.1000N sodium thiosulfate (Na₂S₂O₃) until the solution turns a faint straw color. The faint straw color indicates the titration is near its end-point. Starch indicator (1 ml of 0.5% starch) is then introduced to the titration flask so that the solution changes from pale straw yellow to black or dark blue. This is the color of the complex that forms between starch and iodine. The more intense blue/black color serves to sharpen the end-point. Continue to titrate drop by drop until the blue/black color is completely discharged and the solution is colorless. The volume (V) of 0.1000N sodium thiosulfate titrant required to affect the end-point is used to calculate the activity of the halogen-containing solution.

Calculation:

To express the results as weight % as Cl₂:

$$Wt \% as {Cl}_{2} = \frac{V \text{/} ml \times N {Na}_{2} {S}_{2} {O}_{3} \times 0.03545 \times 100}{Wt . of sample \text{/} g}$$

To express the results as weight % as Br₂:
Calculate the weight % as Cl₂ and multiply the result by 2.25.
Example: 10.2% as Cl₂=10.2×2.25=22.95% as Br₂

B. DPD Total Halogen Colorimetric Method

The DPD Total Halogen Method is similar to the iodometric titration in that it also is limited to detecting the total halogen level in an aqueous system, but is more accurate when low levels of total halogen are present. A typical DPD Total Halogen Method is performed as follows.

A HACH DR/700 Colorimeter (or equivalent) is utilized for the analysis. To analyze the concentration of halogen as total chlorine on the HACH DR/700 Colorimeter, module number 52.01 (525 nm) should be installed and used in conjunction with HACH Method number 52.07.1. The instrument must be set to the low (LO) range mode so that the display reads to the hundredths place (0.00). Make an appropriate dilution with reverse osmosis (RO) or deionized (DI) water. Fill two sample cells with 10 ml of the diluted sample. Designate one of the cells to be the “blank” and the other to be the prepared sample. Dry the outside of both cells with a paper towel or cloth and make sure the cells are free of fingerprints or smudges. Cap the blank cell and place it into the cell holder with the diamond mark facing you. Cover the cell compartment and press ZERO. The instrument will display 0.00. Remove the “blank” at this time. Add the contents of one DPD Total Chlorine pillow pack (for a 10 ml sample volume) to the prepared sample cell. Cap and shake vigorously. A pink color will develop indicating the presence of halogen. Immediately place the sample cell in the compartment with the diamond facing you, cover the cell compartment and press READ. The instrument display will flash “- - - ” followed by the results in ppm total chlorine.

Calculations:

Total Chlorine: no calculation needed, the instrument reading is the ppm total Cl₂.

Bromine: ppm Br₂=2.25×ppm total Cl₂

(Multiply the result by dilution factor in order to obtain the halogen concentration in the parent (undiluted) solution).

C. DPD Differentiation Colorimetric Method (Also Known as the Palin Modification)

In order to determine how much of the halogen is present as bromine and how much is present as chlorine, the DPD Differentiation Method (also known as the Palin Modification) is utilized. This method allows for the differentiation and quantification of bromine and chlorine in a solution. A typical DPD Differentiation Method is performed as follows.

A HACH DR/700 Colorimeter is utilized for this testing. To analyze the concentration of halogen as free chlorine on the HACH DR/700 Colorimeter, module number 52.01 (525 nm) should be installed and used in conjunction with HACH Method number 52.05.1. The instrument must be set to the low (LO) range mode so that the display reads to the hundredths place (0.00). Make an appropriate dilution. For example, testing a theoretical 300 ppm as Br₂ solution, weigh out 97.0 g distilled water, exactly 1.00 g of solution containing the theoretical 300 ppm as Br₂, and 2.0 g of a 10% glycine solution. The diluted solution is then well mixed in order to bind any free chlorine present into the form a combined form of chlorine, N-chloroglycine. Fill two sample cells with 10 ml of the diluted sample containing the glycine. Designate one of the cells to be the “blank” and the other to be the prepared sample. Dry the outside of both cells off and make sure both cells are free of fingerprints or smudges. Cap the blank cell and place it into the cell holder with the diamond mark facing you. Cover the cell compartment and press ZERO. The instrument will display 0.00. Remove the “blank” at this time. Add the contents of one DPD Free Chlorine pillow pack (for a 10 ml sample size) to the prepared sample. Cap and shake vigorously. A pink color will develop indicating the presence of bromine. Place the sample cell in the compartment with the diamond facing you, close the cover and press READ. The instrument display will flash “- - - ” followed by the results in expressed in ppm free chlorine. This reading is designated “B.” Remove the sample cell from the compartment and add a small amount of potassium iodide (KI) crystals (2-3 crystals) to the prepared sample cell still containing the sample, and vigorously shake. This step allows any glycine-bound chlorine to react with the KI, liberate iodine, which then reacts with the DPD indicator to intensify the pink coloration. Place the sample cell back in the compartment with the diamond mark facing you, close the cover and press READ. The results represent total halogen expressed as ppm free chlorine. This reading is designated “TH.”

Under conditions when all the halogen is present as bromine, the results from the first and second reading are identical, meaning there was no color intensification when the KI crystals were added to the prepared sample cell: TH=B.

If TH>B, then some of the halogen is present as chlorine (C) expressed as ppm free chlorine: Therefore, C=TH−B.

Calculation:

Bromine: ppm Br₂=2.25×B

(Multiply the result by dilution factor in order to obtain the halogen concentration in the parent (undiluted) solution).

### II. Definitions

The following definitions are used in this specification.

“Animal carcasses” means the dead bodies of animals, especially ones slaughtered for food. In this context, carcasses are understood to be the dead bodies of four-legged animals with or without hide such as cattle and hogs and the dead bodies with or without feathers of poultry such as chicken and turkey.

“Meat carcass” means the carcasses of beef, pork, lamb, and any other four-legged animal that is processed for food.

“Poultry” means all birds, including, chicken, turkey, pheasant, squab, and others.

“Trim” means a cut of meat or poultry, such as what is left after primal cuts are removed from the carcass of the butchered animal. These can be the bits trimmed off larger cuts to make them the right size and shape for selling to the consumer and to ensure that they have the correct amount of fat for the grade (Choice, Select, and so on). It primarily includes trimmings off the skeleton. Trim is used to make ground meat and further processed products such as sausage.

“Offal” means the entrails and internal organs of a butchered animal, and generally includes most internal organs other than muscle or bone (e.g., heart, kidneys, tongue, liver, and stomach).

“Primal cut” refers to a piece of meat initially separated from the carcass during butchering. Primal cuts may be sold complete or cut further into smaller sub-primal units

### III. Method of Preparing Hypobromous Acid

One embodiment of the invention is a method for continuously preparing an aqueous solution of hypobromous acid (HOBr) by mixing in water an aqueous solution of hydrogen bromide (HBr) (i.e., hydrobromic acid) with an approximately 1:1 stoichiometric amount of a source of hypochlorite (i.e., each mole of HBr is mixed with approximately one mole of hypochlorite ion from a source of hypochlorite).

Any source of an aqueous solution of HBr may be employed. A particularly convenient source of aqueous HBr is that which is a byproduct of organic bromination reactions used to make, for example, brominated flame retardants. During the reaction of elemental bromine with an organic compound such as bisphenol A, a bromine atom substitutes for a hydrogen atom on the aromatic rings and hydrogen bromide gas is evolved from the reactor. Hydrogen bromide gas is extremely soluble in water and so the gas is captured with a water scrubber. On heating the resultant solution, HBr gas is evolved (along with some water) and the solution steadily decreases in strength until it distills unchanged at 126° C. as the constant boiling azeotrope containing 48% HBr. The azeotropic composition may be used directly in the method of the invention or it may be diluted 50:50 w/w with water prior to use to yield a 24% solution of HBr which is safer to ship than 48% HBr and has less tendency to fume corrosive HBr vapors. In addition, the 24% solution of HBr has less tendency to undergo undesirable photochemical formation of bromine during storage.

Another suitable source of an aqueous solution of HBr is that formed when a solution of sodium bromide (NaBr) is mixed with a stoichiometric amount of a strong mineral acid such as hydrochloric acid (HCl), sulfuric acid (H₂SO₄) or nitric acid (HNO₃) (i.e., each mole of bromide ion is mixed with one mole of proton (hydrogen ion) from the mineral acid). In solution, the bromide (Br⁻) ions from NaBr are fully dissociated, as are the protons and anions of a strong mineral acid. Hence a solution of NaBr and a stoichiometric amount of strong mineral acid is indistinguishable from a solution of HBr and the salt of a mineral acid.

Any source of hypochlorite may be employed. It is convenient if the hypochlorite source is commercially available as an aqueous solution such as sodium hypochlorite (NaOCl) or potassium hypochlorite (KOCl). For economic reasons, solutions of NaOCl are preferred. It is well known that solutions of NaOCl are unstable at normal temperatures and degrade with time. However, the invention does not depend on the age or activity of the NaOCl solution. If the solution has degraded below the 12.5% NaOCl concentration that is commonly supplied, then the end user simply has to adjust the NaOCl delivery pump to a faster pumping rate to compensate for the lower concentration of the degraded solution.

Solid sources of hypochlorite are also suitable for use. These include calcium hypochlorite (Ca(OCl)₂) and lithium hypochlorite (LiOCl). For economic reasons, solid Ca(OCl)₂ is preferred and may be administered in the form granules or tablets. Water is flowed through chemical feeder devices containing the solids. Depending upon the water temperature, and the amount of solid product that the water contacts in the feeder, a hypochlorite solution of a well-defined concentration exits the chemical feeder. The actual concentration can be determined by iodometric titration and expressed as weight % as Cl₂. This permits calculation of the HBr solution flow rate required for mixing with the Ca(OCl)₂ solution. In this way, stoichiometric amounts of HBr and Ca(OCl)₂ are continuously delivered to form the HOBr solution (i.e., each mole of HBr is mixed with one mole of hypochlorite ion from a source of hypochlorite).

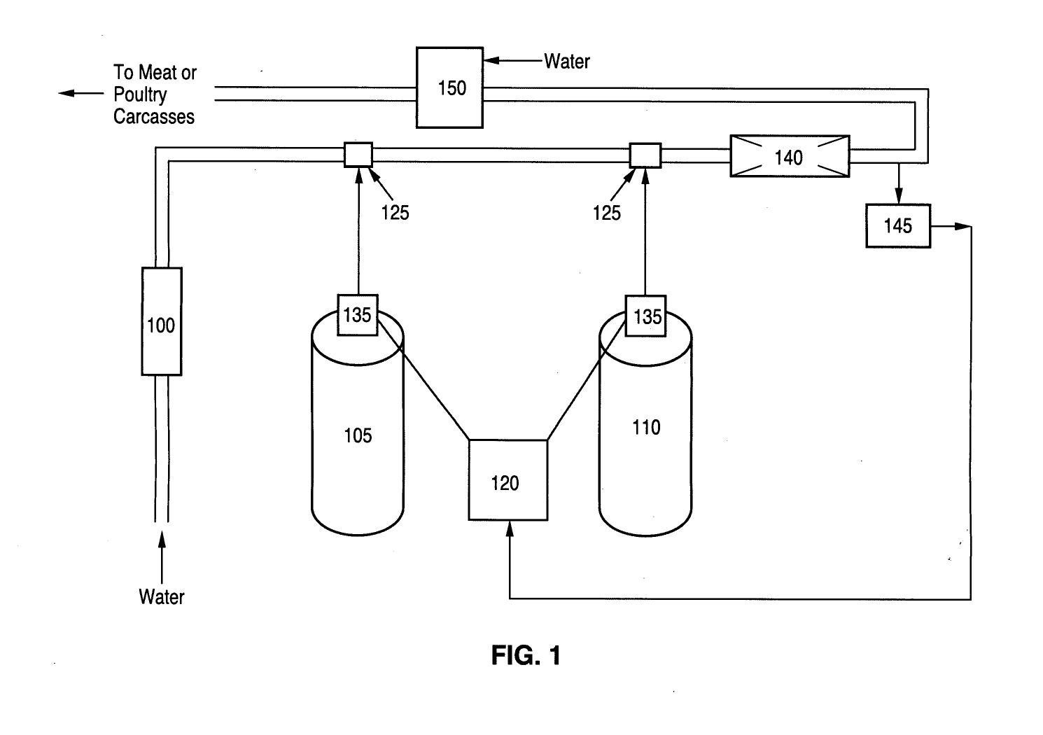

FIG. 1 is a schematic representation of a system used in the method of the invention to continuously prepare a solution of HOBr. A container of aqueous hydrogen bromide solution 105 and a container of a source of hypochlorite, preferably sodium hypochlorite bleach, 110 were each equipped with chemical delivery diaphragm pumps 135. Water was directed through a flowmeter 100 and into a length of pipe where the hydrogen bromide solution was introduced through injection point 125, and sodium hypochlorite solution was introduced through injection point 130. The hydrogen bromide solution and the sodium hypochlorite solution may be added in a sequential manner with either solution first, or they may be added to the water simultaneously through a Tee fitting. In this case, the hydrogen bromide solution and the sodium hypochlorite solution are introduced to the two arms of a Tee fitting and the mixture is injected into the pipe of water. Because the dilution water flow is typically controlled by a solenoid or valve, this method of addition can be either continuous or intermittent depending upon the position of the flow control valve. The water containing hydrogen bromide and sodium hypochlorite solutions was mixed using an in-line static mixer 140. A pH probe and meter 145 monitored the pH of the mixture and adjusted the rate of addition of hydrogen bromide solution or sodium hypochlorite solution through a pH controller 120 that is interfaced to the chemical delivery diaphragm pumps 135. The mixture was then directed to a proportional dispenser 150 set to dilute the mixture to the desired HOBr concentration with water. The degree of dilution depends on the required concentration of HOBr. Instead of proportional dispenser 150 a conventional diaphragm or centrifugal pump may be used to effect the desired dilution provided the volumetric flows rates of the dilution water and activated solution are known.

### Examples 1-3

The apparatus represented in FIG. 1 was used to continuously generate solutions of HOBr that were close to 300 ppm (as Br₂). The results are shown in Table 2.

TABLE 2
Flow Rates and Dilution Ratios

| | | | | Br₂ | | |
|---|---|---|---|---|---|---|
| | | | | concentration | Dilution | |
| | | 24% HBr | | entering | ratio at | |
| | Water flow | flow | 12.5% NaOCl | proportional | proportional | Final Br₂ |
| Example | through | through | through pump | dispenser | dispenser | Concentration/ |
| No. | flowmeter 100 L/min | pump 35 ml/min | 35 ml/min | 150/ppm | 150 | ppm |
| 1 | 3.785 | 38.4 | 68.9 | 5865 | 19.6 | 300 |
| 2 | 3.785 | 52.5 | 94.7 | 8050 | 26.8 | 300 |
| 3 | 1.0 | 0.525 | 0.991 | 289 | N/A | 289 |

### Example 4

The relative stability of HOBr derived from NaOCl-activated HBr and HOBr derived from DBDMH was compared side-by-side. A solution of HOBr (600 ppm as bromine) was used in the comparison because this is the amount of bromine that typically exits the commercial DBDMH feeders when the solid product is dissolved. The activity of the solutions was measured using the DPD Total chlorine colorimetric method. Solutions were stored in the dark to prevent photodegradation due to UV light exposure. The temperature ranged from 70-75° F. for the duration of the test.

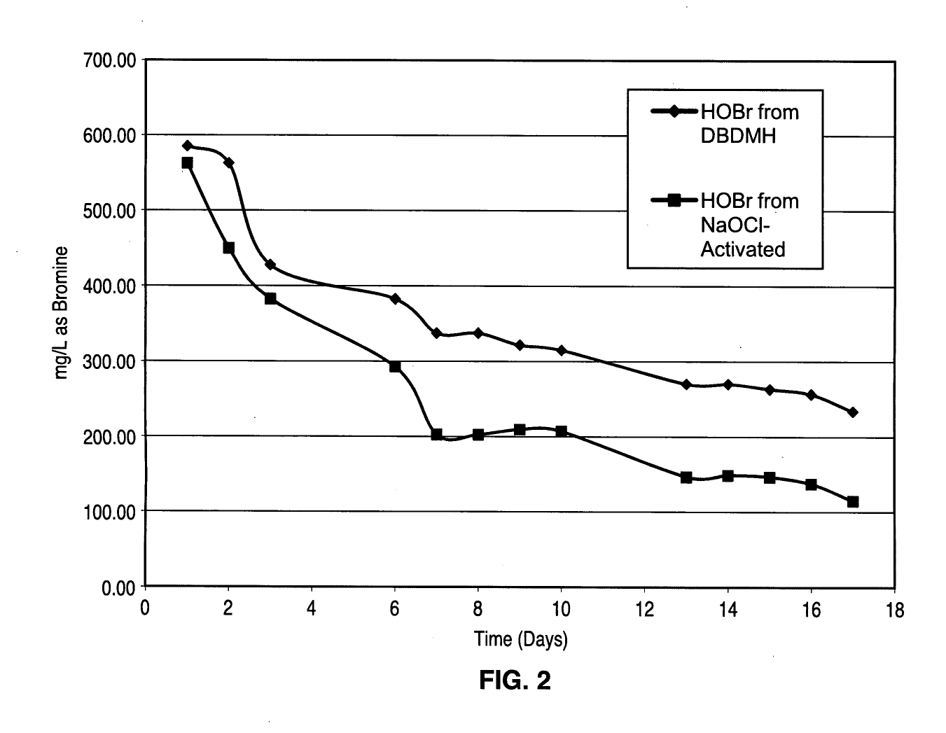

The HOBr decay profiles for the 600 ppm (as bromine) solutions derived from NaOCl-activated HBr solution and DBDMH solution are plotted in FIG. 2.

FIG. 2 demonstrates that the presence of DMH does have a stabilizing effect on the HOBr, but contrary to the teachings of Howarth et. al, it is not an essential requirement for production of a solution which might be stored several days prior to use. The half-lives of the HOBr in the respective solutions are calculated as follows:

Graphs of ln(Co/Ct) where Co is the initial concentration of HOBr and Ct is the concentration at day t were close to straight lines for both the DBDMH and NaOCl-activated HBr derived solutions. (the regression analysis correlation coefficient, R² values were close to 1). The R² value for the DBDMH and the NaOCl-activated HBr solutions were 0.9251 and 0.9302, respectively. The slope for the linear regression line for the NaOCl-activated HBr solution indicated the HOBr decayed with a rate constant of 0.0880 day⁻¹. The slope for the linear regression line for the DBDMH indicated that the HOBr solution decayed with a rate constant of 0.051 day⁻¹.

The half-lives of HOBr from the HBr-activated solution and the DBDMH solution were calculated by dividing the slopes of the respective regression lines by 0.692—the natural logarithm (ln) of 2. These figures are displayed in Table 3 below.

TABLE 3

| Solution | Half-Life |
|---|---|
| NaOC1-activated HBr solution (600 ppm | 7.9 days |
| as bromine) | |
| DBDMH (600 ppm as bromine) | 13.4 days |

### Example 5

The previous examples (1-4) demonstrate that solutions of sodium hypochlorite readily activate HBr to HOBr instantaneously and, depending on the final concentration of HOBr, typically with 100% conversion. Thus, it would be expected that all hypochlorite solutions (e.g. potassium hypochlorite (KOCl)), would work in an identical fashion. This example determined the efficiency of the process when solid sources of hypochlorite, such as calcium and lithium hypochlorite, are used to activate HBr. In this example, solid calcium hypochlorite was used to activate HBr to determine the efficiency of bromide ion utilization and the stability of the resultant activated solutions.

In this example, 48% HBr was activated using three different techniques of using solid calcium hypochlorite (70% expressed as Cl₂). Techniques 1 and 2 utilized stoichiometric amounts of 48% HBr and solid calcium hypochlorite (70% as Cl₂) to generate a solution of HOBr (theoretically 5000 ppm expressed as bromine). In technique 1, 48% HBr was introduced to a slurry of calcium hypochlorite in city water. In technique 2, a calcium hypochlorite slurry was introduced to city water containing the 48% HBr. Technique 3 is the same order of addition as technique 2 except the amount of calcium hypochlorite (70% as Cl₂) that was introduced was based solely on the observed color change of dark orange to bright yellow. The relative % conversion of bromide ion into HOBr was assessed for each method, in addition to determining the decay kinetics for each activated solution.

In the first technique, calcium hypochlorite (70% as Cl₂) (3.023 g) was added to the city water (942.0 g) to produce a slurry, because not all the solid components in the calcium hypochlorite were fully solubilized. Using a magnetic stir plate the slurry was mixed gently. While mixing, the 48% HBr (5.00 g) was smoothly added to the slurry within approximately 15 seconds. After all the 48% HBr was added, a clear, solids-free solution was obtained. During the addition, the mixture turned from an initial pale yellow pale color to dark orange then to a bright yellow solution.

In the second technique, the 48% HBr (5.00 g) was introduced to the city water (942.0 g) first. Using a magnetic stir plate the solution was mixed gently. While mixing, the calcium hypochlorite (70% as Cl₂) (3.0224 g) was smoothly added to the solution over the course of 30 seconds. During the addition, the mixture turned from an initial pale yellow color to dark orange and then to a bright yellow solution. No turbidity indicative of undissolved solids was observed throughout the activation process.

In the third technique, the 48% HBr (5.00 g) was introduced to the city water (942.0 g) first. Using a magnetic stir plate the solution was mixed gently. While mixing, calcium hypochlorite (70% as Cl₂) was smoothly added to the solution until the color of the solution changed from pale yellow to dark orange to bright yellow to signal the termination of the calcium hypochlorite addition. The amount of calcium hypochlorite (70% as Cl₂) added at this point was 2.88 g. The calcium hypochlorite (70% as Cl₂) addition took approximately three minutes.

For all three techniques, the activated solutions were stored away from direct UV light to prevent photodegradation during the stability testing. The tests were performed at ambient temperature. The solutions were initially tested using the DPD Differentiation Method (also known as the Palin Modification) to confirm no chlorine was present after activation. After verifying no excess chlorine was present, the solutions were analyzed using the DPD Total Halogen Method. The results were expressed as ppm as bromine. These results were used to determine the percent bromide ion activated to HOBr. Then the decay profiles were used to determine the half-lives and decay rate constants.

Graphs of ln(Co/Ct) (where Co is the initial concentration of HOBr and Ct is the concentration at time t) plotted against time t. The R² values for techniques 1, 2, and 3 each plotted close to a straight line (the regression analysis correlation coefficient, R² value was close to 1) for all three Ca(OCl)₂-activated HBr solutions. The R² values for techniques 1, 2, and 3 were 0.9375, 0.8609, and 0.9528, respectively. From this line the half-lives and rate constants were determined. The half-lives were calculated by dividing the slopes of the respective regression lines by 0.693—the natural logarithm of 2. The slope of the respective linear regression lines indicated the rate constant for HOBr decomposition (expressed as Br₂) at each concentration. These figures are reported in Table 4 below.

TABLE 4

| | | | % Br⁻ ion | | |
|---|---|---|---|---|---|
| Tech- | Conc. | pH After | Activated to | | Rate |
| nique | (ppm as Br₂) | Activation | HOBr | Half-Life | Constant |
| 1 | 4702.5 ppm | 7.41 | 94.24% | 270.6 min | 0.0026 min⁻¹ |
| 2 | 5000 ppm | 7.28 | 100% | 336.6 min | 0.0021 min⁻¹ |
| 3 | 4522.5 ppm | 7.49 | 90.64% | 181.2 min | 0.0038 min⁻¹ |

The solid calcium hypochlorite successfully activated the HBr but subsequently the HOBr generated was not as stable as when HBr was activated with sodium hypochlorite. The percent bromide ion conversion into HOBr is high in all cases. However, compared to similar concentration solutions prepared using aqueous sodium hypochlorite solutions, the calcium hypochlorite-activated solutions degrade more rapidly. It is noteworthy that the least efficient conversion of Br⁻ ion into HOBr and the least stable activated solution was prepared when the color transition method was used to determine the time to terminate the Ca(OCl)₂ addition. This further contrasts the method advocated by Howarth (U.S. Pat. Nos. 5,641,520 and 5,422,126) which stated that the observation of the color transition was the signal to cease the addition of hypochlorite. Consequently, activation of HBr using a stoichiometric amount of solid hypochlorite is the preferred method.

It can thus be concluded that solid sources of hypochlorite such as Ca(OCl)₂ are also suitable for activation of HBr into HOBr. Noting that low conversion of bromide ions to HOBr represents the major chemical cost limitation and hence the economics of the process, and for reasons of improved storage stability, it is preferred that stoichiometric amounts of HBr solution and solid hypochlorite are employed (i.e. each mole of HBr is mixed with one mole of hypochlorite ion from calcium hypochlorite).

### Example 6

Another method of forming an aqueous HBr solution is through the combination of sodium bromide and hydrochloric acid. During the first attempt to form a theoretical 24% HBr solution, 46% sodium bromide (40.00 g) was accurately weighed to a beaker. To this, a stoichiometric amount of 31.4% hydrochloric acid (20.78 g) was smoothly added with gentle agitation. However, a precipitation reaction immediately occurred. The precipitate was white and thought to be the formation of solid NaCl salt. To the precipitated sample, sufficient reverse osmosis (RO) water (18.02 g) was added until a homogenous solution was achieved. The theoretical concentration for the diluted solution was 18.36% HBr. The second attempt was to prepare the 18.36% HBr solution directly, and without precipitation by the addition of excess water before the hydrochloric acid was introduced. The preparation of the second sample required a stoichiometric amount of 46% sodium bromide (40.00 g), which was added to RO water (17.6 g) and mixed. Then a stoichiometric amount of hydrochloric acid 31.4% (20.78 g) was added to the sodium bromide and water under gentle agitation. This produced a homogeneous solution equivalent to a theoretical 18.46% HBr. The solution was stored in a clear container with lid and stored at 35-40° F. for two days in the laboratory refrigerator. The sample was determined to have no precipitate after the two days, but a few small crystals formed after a period of 15 days at the depressed temperature.

### IV. Method of Using Hypobromous Acid to Wash Animal Carcasses, Trim, and Offal

A second embodiment of the invention is a method of using the resultant HOBr solutions to wash an animal carcass, animal trim, or animal offal for sufficient time to reduce the number of microorganisms, including human pathogenic bacteria, associated with the carcass, trim, or offal.

The HOBr solutions prepared using the method of the first embodiment of the invention display antimicrobial properties to microorganisms resident on and within the animal carcass, animal trim, or animal offal. These include spoilage microorganisms such as yeast, mold, and fungi, but the solutions prepared by the method of the invention are especially effective against human pathogenic microorganisms including enteric bacteria such as E. coli O157:H7 and Salmonella typhimurium.

The animal carcasses, animal trim, or animal offal are contacted with the HOBr solutions in any manner that permits good distribution of the HOBr solution over the animal piece. This can be accomplished by dipping or submerging the animal piece in a tank of HOBr solution, subjecting the animal piece to a pressurized spray of HOBr solution, or subjecting the animal piece to a fog of HOBr solution produced by directing the HOBr solution through fogging apparatus. During the dipping, submersion, spraying and fogging, the animal piece may be subject to mechanical action through agitation or by physical scrubbing with brushes. During spraying, the pressure of the HOBr solution spray may be increased to further impinge the animal piece. Enhanced impingement allows the HOBr solution to penetrate the surface of the animal piece and attack embeddied microorganisms.

The animal carcasses, animal trim, or animal offal are contacted with the HOBr solution for a time sufficient to effect a reduction in the number of human pathogenic bacteria associated with the animal pieces. Spraying may be accomplished in a dedicated cabinet in which an animal carcass is subject to a pressurized spray (between 25 and 250 psig) for less than one minute. Animal trim may be sprayed for less than five seconds with a low-pressure stream of HOBr solution from a spray bar as it moves along a conveyor belt. Most poultry processing facilities cool the product by submerging it for 30-180 minutes in a chiller tank containing an antimicrobial chemical. The chilled water solution is approximately 35° F.

### Example 7

Some animal carcass washing facilities prefer to directly prepare the animal carcass wash (i.e., omitting the step of diluting a more concentrated solution). This example determined the optimum activation conditions in terms of the % conversion of Br⁻ ion into HOBr, the rate of the activation reaction, and the storage stability of the resultant activated solution.

Direct Preparation of Ready-to-Use (RTU) Carcass Wash

The relative stability of HOBr (expressed as Br₂) was compared at three different low concentrations. The HOBr (expressed as Br₂) concentrations compared were 600 ppm, 300 ppm, and 50 ppm. The solutions were activated separately by adding 1:1 stoichiometric amounts of HBr and NaOCl bleach to a known amount of city water to theoretically generate the desired concentrations, 600 ppm, 300 ppm, and 50 ppm of HOBr (expressed as Br₂). The calculated amounts are reported in Table 5. The 48% HBr was introduced to a known amount of city water. Using a magnetic stir plate the solution was mixed gently until homogenous. While mixing, a stoichiometric amount of sodium hypochlorite bleach of known activity (determined by the iodometric titration) was smoothly added to the solution. Any color transition was noted and the final pH was measured. The weights or volumes of reactants used to prepare the activated solutions are reported in Table 5.

The activated solutions were shielded from direct UV light to prevent photodegradation of HOBr during the stability testing. The tests were performed at ambient temperature. The solutions were initially tested using the DPD Differentiation Method (also known as the Palin Modification) to verify that no chlorine was present after activation. After confirming no excess chlorine was present, the solution was analyzed using the DPD Total Halogen Method. The results were expressed as ppm as bromine. These results were used to determine the percent bromide that was converted to HOBr. Decay profiles for each solution were used to determine the half-life and decay rate constant of the HOBr.

TABLE 5
Weights/Volumes Used for Preparation of NaOC1-Activated
HBr Solutions

| HOBr Solution | City | | |
|---|---|---|---|
| (Theoretical) | Water | 48% HBr | Sodium Hypochlorite Bleach |
| 600 ppm | 900.0 ml | 0.40 ml | 1.9 ml Bleach 12.28% as Cl₂ |
| as bromine | | | |
| 300 ppm | 900.0 ml | 0.20 ml | 2.45 ml Bleach 11.64% as Cl₂ |
| as bromine | | | |
| 50 ppm | 3999.0 g | 0.2295 g | 0.7368 g Bleach 13.13% as Cl₂ |
| as bromine | | | |

Graphs of ln(Co/Ct) (where Co is the initial concentration of HOBr and Ct is the concentration at time t) were plotted against time t. All were close to straight lines (the regression analysis correlation coefficient, R² values were close to 1) for all three NaOCl-activated HBr solutions. The R² values for the 600 ppm, 300 ppm, and 50 ppm (expressed as Br₂) solutions were 0.9302, 0.8156, and 0.9352, respectively. From the lines, the half-life and decay rate constants were determined. The half-lives were calculated by dividing the slopes of the respective regression lines by 0.693—the natural logarithm of 2. The slope of the respective linear regression lines indicated the rate constant for HOBr decomposition (as Br₂) at each concentration. These figures are reported in Table 6.

TABLE 6
Summary of Decay Profiles

| | | | | Maximum % Br⁻ | | |
|---|---|---|---|---|---|---|
| | | | | Ion Activated | | |
| HOBr | | Conc. | | to HOBr | | |
| Solution | Color | (ppm as | pH (After | (time interval | Half- | Rate |
| (Theoretical) | Transition | Br₂) | Activation) | after activation) | Life | Constant |
| 600 ppm as | None - pale | 562.5 ppm | 7.51 | 87.73% (1 min) | 7.88 | 0.088 day⁻¹ |
| bromine | yellow | | | | days* | |
| | throughout | | | | | |
| | NaOCl | | | | | |
| | addition | | | | | |
| 300 ppm as | None - pale | 357.75 ppm | 7.27 | 100% (0.5 min) | 1837.8 min† | 0.0004 min⁻¹ |
| bromine | yellow | | | | (1.28 | |
| | throughout | | | | days) | |
| | NaOCl | | | | | |
| | addition | | | | | |
| 50 ppm as | None - pale | 48.15 ppm | 8.12 | 94.73% (5 min) | 680.4 min† | 0.001 min⁻¹ |
| bromine | yellow | | | | (0.47 | |
| | throughout | | | | day) | |
| | NaOCl | | | | | |
| | addition | | | | | |

*Stability of 600 ppm as bromine solution tracked once per day for 17 days
†Stability of 300 ppm and 50 ppm as bromine solutions tracked every 30 minutes for 3.5 hours

These solutions did not undergo any significantly visible color transitions during the activation of HBr. The endpoint was determined by calculating the stoichiometric amount of NaOCl bleach required to activate all the HBr. The equation below was used to determine the maximum percent of bromide converted to HOBr (expressed as Br₂).

$$\% {Br}^{-} Activated = \frac{ \begin{matrix}Actual Concentration of \\ HOBr Recovered ( expressed as {Br}_{2} )\end{matrix} }{\begin{matrix}Theoretical Concentration of HOBr \\ Generated ( expressed as {Br}_{2} )\end{matrix}} \times 100$$

In Table 6 above, the time correlating to the maximum conversion of Br⁻ ion to HOBr is displayed in parentheses under its respective maximum percent-activated value. Based on this study, the lower boundary concentration was defined as HOBr (50 ppm as bromine). At this concentration, the half-life of the HOBr was adequate for storage up to one day, and the conversion of HBr to HOBr was still high (94.73%). Any lower concentration of HOBr than 50 ppm as bromine would be of little practical value to use in a meat or poultry plant engaged in sanitizing the animal carcasses, trim, and offal.

Indirect Preparation of Ready-to-Use (RTU) Carcass Washes from HOBr Solutions of Higher Concentration

When HBr is activated with sodium hypochlorite bleach the resultant hypobromous acid (HOBr) solution has long been considered by those knowledgeable in the art to be too unstable for practical commercial use (Howarth, U.S. Pat. Nos. 5,641,520 and 5,422,126). This example reports the decay constants and the half-life for two concentrations of HOBr. These were chosen to be above the lowest boundary condition of 50 ppm, and below the upper boundary condition of 30,000 ppm (as Br₂) (see example 12). The purpose of this study was to provide an indication of the persistency of hypobromous acid in the activated solution (expressed as Br₂). It also guides users of the time frame through which the NaOCl-activated HBr solutions may be used without appreciable decay. An additional objective of this example was to observe the change in pH of the activated HBr solutions over time.

A low and a high concentration of activated HBr solutions were employed in this study. The solutions were made by introducing sodium hypochlorite bleach to the HBr and city water until the color transition from dark orange to pale yellow was achieved, whereupon further addition of NaOCl was discontinued. Once the HBr solutions were activated, an initial pH and temperature were recorded and activity of HOBr was measured using the iodometric titration (results expressed as Br₂). The activated solutions were stored away from direct UV light to prevent photodegradation during the stability testing. The test was performed at ambient temperature. The activities of the solutions were tested periodically for 7-8 hours, along with recording the pH and temperature of each solution. The temperature ranged from 74-80° F. for all three studies.

The volumes used to prepare the high and low concentrations of HOBr are displayed in Table 7 below. Throughout this example, the low concentration HOBr solution (4800 ppm) is referred to as Solution 1 and the high concentration HOBr solution (8620 ppm) is referred to as Solution 2.

TABLE 7

| Low Concentration HOBr (4800 ppm | High Concentration HOBr |
|---|---|
| as Br₂) (Solution 1) | (8620 ppm as Br₂) (Solution 2) |
| 896.6 mL City Water | 844.4 mL City Water |
| 3.45 mL 48% HBr | 5.6 mL 48% HBr |

Hard city water was accurately measured out with a graduated cylinder. The HBr 48% was measured using a graduated pipette and added to the water. The solution was gently agitated before continuing. To activate the HBr, a known concentration of sodium hypochlorite bleach was added to the 48% HBr and water while gently mixing. The solution was initially colorless. As the sodium hypochlorite bleach was added, the color changed from colorless to bright yellow to a dark orange/red then to a pale yellow. The pale yellow indicated that further addition of NaOCl be discontinued. At this point, the pH of the activated solution should be close to neutral. The color of the solutions slowly regressed back to dark orange as time elapsed. The color regression occurred because of the instability of HOBr. After the HBr solution was activated with NaOCl, the time was recorded as zero minutes (T₀) and samples and readings were started.

### Example 8

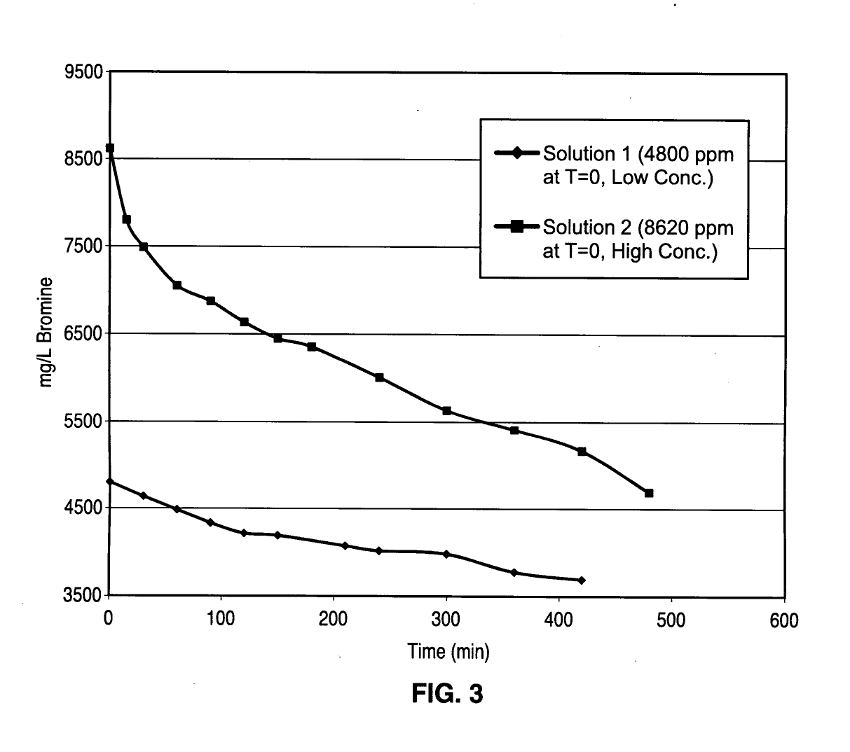

FIG. 3 illustrates the persistency of the HOBr (expressed as Br₂) for the low and high concentration solutions of activated HBr. Solution 1 (low concentration HOBr solution) utilized 3.45 mL of HBr 48% in 896.6 mL of city water and was activated with 19 mL of Bleach (9.29% as Cl₂). After the solution was activated, the activity tested at 4800 ppm as bromine, but due to the unstable nature of the HOBr, after seven hours the activity decayed to 3692 ppm as bromine. Solution 2 (high concentration HOBr solution) utilized 5.6 mL of HBr 48% in 844.4 mL of city water and was activated with 25 mL of bleach (12.5% as Cl₂). Initially the solution generated 8620 ppm as bromine, but due to the unstable nature of the HOBr, after eight hours the activity decayed to 4694 ppm as bromine.

The overview of the decay of HOBr with time provides users with a tentative means to determine the activity of the NaOCl-activated HBr solutions over time if the solution is not exposed to UV light. The half-life of each solution is reported in Table 8.

The pH of the NaOCl-activated HBr solutions is driven by the decay of HOBr. Therefore, the pH was observed while the HOBr decayed. Once HBr is activated with sodium hypochlorite, the pH is between 7 and 7.8. The pH drifts lower as HOBr decays according to the following equation:

2HOBr=O₂+2HBr

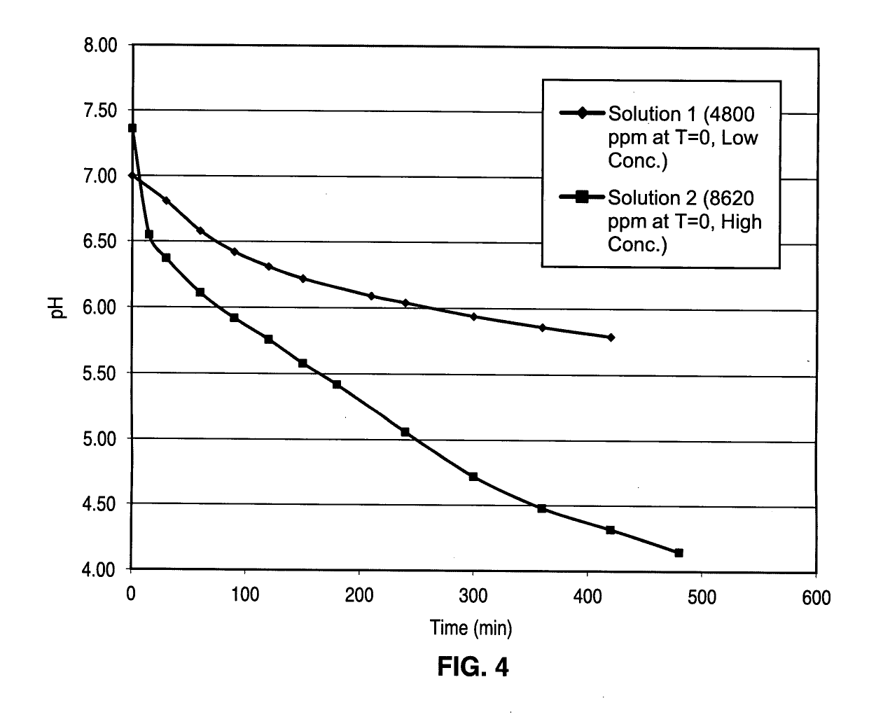

In FIG. 4, the pH was tracked over the time span of the study for both HOBr solutions. The initial pH of Solution 1, after activation, was 7.00 and after seven hours the pH dropped to 5.79. The initial pH of Solution 2, after activation, with sodium hypochlorite bleach was 7.36 and after eight hours the pH dropped to 4.15.

A graph of ln(Co/Ct) for the HOBr solutions (where Co is the initial concentration of HOBr and Ct is the concentration at time t) were plotted against time t. The plot was close to a straight line (the regression analysis correlation coefficients, R² values, were 0.9492 and 0.9357 for Solutions 1 and 2, respectively). From these lines, the half-lives and decay rate constants were determined. The half-lives were calculated by dividing the slope of the regression lines by 0.693—the natural logarithm of 2. The slope of the linear regression line indicated the rate constant for HOBr decomposition

The half-lives for the decay of HOBr (expressed as Br₂) in Solutions 1 and 2 (calculated by dividing the slopes of the respective regression lines by 0.692—the natural logarithm of 2) are displayed in Table 8 below. The half-lives are reported in minutes and hours. Solution 1 has approximately twice as long a half-life as Solution 2.

TABLE 8
Reported Half-lives

| | Half-Life of HOBr |
|---|---|
| Solution 1 | 1206 min (20 hrs) |
| (low concentration HOBr solution) | |
| Solution 2 | 656 min (11 hrs) |
| (high concentration HOBr solution) | |

The U.S. Food and Drug Agency (FDA) has approved the use of DBDMH solutions containing a maximum of 300 ppm as Br₂ for washing animal carcasses (Food Contact Notification, no. 792). It is therefore predicted that carcasses, trim, and offal washing or spraying with HOBr solutions prepared by the NaOCl-activated HBr solutions will require a maximum of 300 ppm as bromine. When activating a low or high concentrated solution of HOBr, as performed in this example, the solutions would need to be diluted accordingly (depending on the concentration of HOBr utilized, high or low concentration). The dilutions are to obtain a 300 ppm (expressed as Br₂) solution are displayed below in Table 9.

TABLE 9
Dilution factors

| Original Concentration | Dilution Factors (w/w)† |
|---|---|
| Solution 1 | Must dilute by a factor of 15.6 |
| (Low concentration HOBr solution) | |
| Solution 2 | Must dilute by a factor of 28.7 |
| (High concentration HOBr solution) | |

†The dilution can be accomplished with a proportional dispenser or with a separate diaphragm of centrifugal pump provided the volumetric flow rates of the dilution water and NaOCl-activated solution are known.

### Example 9

The microbiological efficacy of the HOBr derived from NaOCl/HBr and the HOBr from DBDMH were compared against a culture of E. coli O157:H7 bacteria that was sprayed onto the surface of beef and pork meat.

Meat processing facilities commonly treat beef and pork with antimicrobial solutions for about 30 seconds by spraying the beef and pork carcasses and trim with the solution in a spray cabinet. To simulate this process, a small spray cabinet was constructed for the study. A 30-gallon, open-headed drum was equipped with three ½ inch PVC section of pipe that were vertically oriented and positioned 120 degrees apart. Each section of pipe had two spay nozzles four inches apart positioned to form a spray zone in the center of the drum. An air-assisted diaphragm pump was used to deliver the test solution into the three ½ inch PVC pipe sections and through the nozzles. A regulator on the air pump was used to adjust the pressure of the spray as necessary.

DBDMH granules manufactured by Albemarle Corporation were obtained from a local pool store. A saturated stock solution was made by mixing the product in water followed by gravity filtration to remove any undissolved solids. The stock solution was added to potable water in order to obtain the appropriate concentration.

A 48% solution of HBr was obtained from Chemtura Corporation. For this study, hypobromous acid (HOBr) was created on-site by combining solutions of hydrogen bromide and sodium hypochlorite.

A stock solution of a field strain of E. coli O157:H7 was incubated at 35° C. for four days in Sigma Nutrient Broth for microbial culture. Three daily, consecutive transfers of the inoculums were made to ensure that a sufficient concentration of E. coli O157:H7 was available for the study. The broth and bacteria mixture was then centrifuged leaving the E. coli O157:H7 to be re-suspended in approximately 500 ml Butterfield's Buffer. The E. coli O157:H7 buffer solution was serially diluted and plated on 3M Petrifilm E. coli plates, incubated at 35° C. for 48 hours where it was determined that the E. coli O157:H7 population was 6.76×10⁷ CFU/ml or log₁₀ 7.83.

The type of beef used was chuck roast, which was cut into nine equal pieces. The average weight of beef piece used in this portion of the study was 257.1 g. Nine boneless pork chops of average weight of pork 142.9 g were used.

Before spraying the meat, the concentration of HOBr in the respective solutions was measured using a Hach DPD Total Chlorine colorimeter, and the results expressed as ppm Br₂.

This study performed in triplicate, i.e., three pieces of each meat type was subjected to HOBr from NaOCl-activated HBr and from DBDMH for comparison with a city water control.

In summary:
Beef—
   a) Control: Three beef pieces—city water
   b) DBDMH: Three beef pieces—288 ppm Br₂
   c) NaOCl/HBr: Three beef pieces—279 ppm Br₂
Pork—
   a) Control: Three pork pieces—city water
   b) DBDMH: Three pork pieces—288 ppm Br₂
   c) NaOCl/HBr: Three pork pieces—279 ppm Br₂

During the 30 second spray, a piece of meat was held by a hook and moved up and down in the spray zone of the spray cabinet with rotation to ensure even distribution of the solution over the surface. The spray pressure was set at 50 psi.

Immediately after each piece was sprayed, a sample of the wash solution was taken from the bottom of the spray cabinet drum for microbial analysis. The solutions were plated on 3M Petrifilm E. coli plates and incubated at 35° C. for 48 hours.

After spraying, each meat piece was gently shaken three times to remove excess liquid and returned to a new, sterile bag containing 200 g of city water. The bag was sealed and then vigorously agitated manually for one minute to dislodge any viable surface-associated bacteria from the meat and into the aqueous phase. The water was then plated using 3M Petrifilm E. coli plates and incubated at 35° C. for 48 hours, after which the plates were enumerated. All plating for E. coli was performed within five minutes of completing the spray.

The microbiological quality of the wash waters is summarized in Table 10 where the two sources of HOBr are compared to that of a city water control.

TABLE 10

| | log10 | |
|---|---|---|
| Description | (remaining) | log10 reduction |
| Control Beef | 5.01 | N/A |
| DBDMH Beef | 0.48 | 4.53 |
| NaOCl/HBr Beef | 0.15 | 4.86 |
| Control Pork | 5.18 | N/A |
| DBDMH Pork | 0.99 | 4.19 |
| NaOCl/HBr Pork | 0.39 | 4.79 |

It can be seen that both DBDMH and NaOCl-activated HBr treatments afford good reductions of bacteria present in the wash water. However, the NaOCl-activated HBr displays a measurably higher efficacy than DBDMH.

The average concentrations of viable E. coli O157:H7 bacteria remaining on both the beef and the pork after being sprayed with the different sources of HOBr is compared to the amount remaining for just a spray with city water in Table 11.

TABLE 11
Reduction in the Number of Surface-Associated Bacteria Remaining
on the Meat after Spraying the Pieces with Solutions of HOBr from
DBDMH and NaOCl/HBr

| | log10 | log10 | |
|---|---|---|---|
| Description | (remaining) | reduction | % reduction |
| Control Beef | 6.15 | — | — |
| DBDMH Beef | 5.56 | 0.59 | 74.30 |
| NaOC1/HBr Beef | 5.45 | 0.70 | 80.03 |
| Control Pork | 6.43 | — | — |
| DBDMH Pork | 5.71 | 0.72 | 80.95 |
| NaOC1/HBr Pork | 5.25 | 1.18 | 93.39 |

The same trend is apparent as was seen in the wash water; both DBDMH and NaOCl-activated HBr treatments afford good reductions in the number of surface-associated bacteria. However, the NaOCl-activated HBr displays a measurably higher efficacy than DBDMH on both beef and pork.

### Example 10

In the processing of poultry, birds that are deemed by the USDA inspectors to have undesirable levels of fecal contamination are directed to a dedicated cabinet where they are sprayed with an antimicrobial solution. If the fecal contamination were not removed, birds harboring the pathogenic Salmonella organism would enter the human food chain. Therefore, the microbiological efficacy of the HOBr derived from NaOCl/HBr and the HOBr from DBDMH were compared on chicken inoculated with a culture of Salmonella typhimurium (ATCC 14028) bacteria.

DBDMH granules manufactured by Albemarle Corporation were obtained from a local pool store. A saturated stock solution was made by mixing the product in water followed by gravity filtration to remove any undissolved solids. The stock solution was added to potable water in order to obtain the appropriate concentration.

A 48% solution of HBr was obtained from Chemtura Corporation. For this study, hypobromous acid was created on-site by combining hydrogen bromide and sodium hypochlorite.

A stock solution of Salmonella typhimurium (ATCC 14028) was incubated at 35° C. for four days in Sigma Nutrient Broth for microbial culture. Three daily, consecutive transfers of the inoculums were made to ensure that a sufficient concentration of Salmonella typhimurium was available for the study. The broth and bacteria mixture was then centrifuged leaving the Salmonella typhimurium to be re-suspended in approximately 500 ml Butterfield's Buffer. The Salmonella buffer solution was serially diluted and plated on 3M Petrifilm Enterobacteriaceae Plates, incubated at 35° C. for 24 hours where it was determined that the Salmonella typhimurium population was 2.34×10⁸ or log₁₀ 8.37 CFU/ml (colony forming units per milliliter).

Three whole, uncooked chickens were purchased from a local grocer. The average weight of the whole chickens was 5.30 pounds. The organs were removed from each chicken and subsequently, each chicken was cut evenly in half down the back leaving six equal halves which contained a back, breast, thigh and leg. The chicken halves were then patted dry with a paper towel, sprayed liberally on all sides and marinated with Salmonella typhimurium—Butterfield's Buffer solution inoculums for two hours, turning occasionally.

The six chicken pieces were introduced to the spray cabinet used in Example 9. This study was performed in duplicate, i.e., two chicken halves were subjected to each test substance for 30 seconds. During the 30 second spray, a chicken half was held by a hook and moved up and down while rotating to ensure even distribution of the test spray at 40 psi. The concentration of HOBr was measured prior to spraying the meat pieces by using a HACH DR/700 Colorimeter and HACH 10 ml DPD Total Chlorine pillow packets.

In summary:
a) Control: Two chicken halves—city water
b) DBDMH: Two chicken halves—295 ppm as total bromine
c) NaOCl/HBr: Two chicken halves—275 ppm as total bromine

After spraying, the chicken half was gently shaken three times to remove excess liquid and returned to a new, sterile bag and taken to the lab. 300 g of sterile city water was introduced to the bag and the bag was vigorously shaken for one minute to dislodge viable surface-associated Salmonella bacteria remaining on the chicken half. This water was plated using 3M Petrifilm Enterobacteriaceae Plates and incubated at 35° C. for 24 hours, upon which the plates were enumerated. All plating for Salmonella was performed within 10 minutes of completing the spray.

Table 12 reports the average number of bacteria left on the food after being sprayed for 30 seconds with each challenge solution: city water (control), DBDMH, NaOCl-activated HBr. It can be seen that the control averaged a log₁₀ of 6.15 CFU/ml. The chicken sprayed with the DBDMH solution had a log₁₀ reduction in Salmonella typhimurium bacteria of 0.30 CFU/ml (49.88%). There was a log₁₀ reduction of 0.34 CFU/ml (54.29%) when the chicken was sprayed with NaOCl-activated HBr.

TABLE 12
Reduction in the Number of Surface-Associated Bacteria Remaining
on the Poultry after Spraying the Pieces with Solutions of HOBr from
DBDMH and NaOCl/HBr

| | log10 | log10 | |
|---|---|---|---|
| Description | (remaining) | reduction | % reduction |
| Control Chicken | 6.15 | N/A | N/A |
| DBDMH | 5.85 | 0.30 | 49.88 |
| Chicken | | | |
| NaOCl/HBr | 5.81 | 0.34 | 54.29 |
| Chicken | | | |

The same trend is apparent for chicken inoculated with Salmonella typhimurium bacteria as was seen for beef and pork inoculated with E. coli O157:H7 bacteria; although both DBDMH and NaOCl/HBr treatments afford good reductions in the number of surface-associated bacteria, the NaOCl-activated HBr treatment displays a measurably higher efficacy than DBDMH.

### Example 11

Most poultry processing facilities cool the product by submerging it for 30-60 minutes in a chiller tank containing an antimicrobial chemical. The chilled water solution is typically around 35° F. (Food Contact Notification, nos. 334 and 453). Therefore, the microbiological efficacy of the HOBr derived from NaOCl-activated HBr and the HOBr from DBDMH were compared by immersing chickens inoculated with a culture of Salmonella typhimurium (ATCC 14028) bacteria. An inoculum was prepared in the same manner as described in Example 10. This time the inoculum yielded a Salmonella typhimurium population of 3.78×10⁸ CFU/ml, or log₁₀ 8.58. This was then sprayed onto both sides of the chicken halves and left to marinate for two hours. The average weight of the whole chicken used in this portion of the study was 5.20 lbs.

Each test solution was made with chilled water immediately prior to use. For each test solution and the control, two chicken halves were placed in a plastic storage bin containing one quart of test solution. A sterilized ice pack was placed in the bin to accompany the chicken and maintain water temperature. The chicken halves were allowed to sit in the chilled solution for 40 minutes at 35° F., and were turned every five minutes while gently agitating the storage bin. All containers were covered using aluminum foil to prevent degradation of the active ingredients by UV light.

In summary:
a) Control: Two chicken halves—city water
b) DBDMH: Two chicken halves—95 ppm as total bromine
c) NaOCl/HBr: Two chicken halves—100 ppm as total bromine

After spraying, each chicken half was gently shaken three times to remove excess liquid and returned to a new, sterile bag. 300 g of city water was introduced to the bag and the bag was tumbled vigorously for one minute to dislodge viable surface-associated Salmonella bacteria. The water left at the bottom of the bag was plated using 3M Petrifilm Enterobacteriaceae Plates and incubated at 35° C. for 24 hours, upon which the plates were enumerated.

Table 13 contains the average number of bacteria left on the food after the 40 minute challenge test with each solution: city water (control), DBDMH, and the NaOCl/HBr solutions. It can be seen that the control averaged a log₁₀ of 6.54 CFU/ml. The chicken submerged in the DBDMH solution had a log₁₀ reduction in Salmonella typhimurium bacteria of 0.29 CFU/ml (48.71%). The chicken submerged in the NaOCl-activated HBr solution had a log₁₀ reduction of 0.50 CFU/ml (68.38%).

TABLE 13
Reduction in the Number of Surface-Associated Bacteria Remaining
on the Chicken after Immersion for 40 Minutes in Solutions of HOBr
from DBDMH and NaOCl-activated HBr.

| | log10 | log10 | |
|---|---|---|---|
| Description | (remaining) | reduction | % reduction |
| Control Chicken | 6.54 | N/A | N/A |
| DBDMH Chicken | 6.25 | 0.29 | 48.71 |
| NaOCl/HBr Chicken | 6.04 | 0.50 | 68.38 |

For the immersed Salmonella typhimurium inoculated chicken, the same trend is apparent as was for chicken that were sprayed; although DBDMH and NaOCl/HBr treatments both afford good reductions in the number of surface-associated bacteria, the NaOCl-activated HBr treatment displays a measurably higher efficacy than DBDMH.

### V. Compositions of HOBr

A third embodiment of the invention is a composition made by the method of the first embodiment in which the concentration of HOBr is greater than 20,000 ppm and less than 40,000 ppm (as Br₂).

For efficient water management reasons, some animal carcass washing facilities may elect not to prepare an RTU solution directly from HBr and NaOCl bleach as described above. Instead they may wish to prepare a concentrated product to be stored at a central point in the plant, then dilute the product to several different concentrations to be used at different Points-Of-Use (POU) areas of the facility (e.g., different concentrations of HOBr may be required at the carcass wash, trim tables, chiller tanks, on-line processing (OLR), off-line processing, inside-outside bird washes (IOBW), the “hot box” spray where beef and pork carcasses are hung for up to two days to bring their temperature down, and incorporated into ice that animal carcasses or animal carcass trim may come in contact with. Having a central storage point from which the different concentrations of HOBr are prepared by dilution to the required concentration represents a large convenience for the facility.

For these highly concentrated solutions of HOBr, it was therefore considered necessary to define the optimum activation conditions in terms of the % conversion of Br⁻ ion into HOBr, the rate of the activation reaction, and the storage stability of the resultant concentrated activated solutions.

There are limits as to how concentrated a solution of activated HBr can be made. Safety is one factor that would limit the concentration of activated HBr. The activated solution would need to be prepared and stored in a facility without releasing toxic bromine gas into the atmosphere. Second to safety is the efficiency of conversion of the bromide ions to HOBr, as this represents the major chemical cost and hence the economics of the process. A desired process needs to have a relatively high conversion of Br⁻ ion into HOBr in order for the solution to be economically practical. Therefore, the necessary boundary conditions were determined for the use of HBr at the highest possible limit. The boundaries set were determined from the data collected from studies on HBr solutions of different concentrations that had been activated with a sodium hypochlorite solution. This example defines the highest boundary limit (which still has practical use in meat and poultry processing facilities) for a HOBr concentrate that would be diluted down to any desired concentration without posing a hazard.

### Example 12

Indirect Preparation of Ready-to-Use (RTU) Carcass Washes from Concentrated Solutions

The relative stability of HOBr (expressed as Br₂) was compared at three different high concentrations. The theoretical HOBr (expressed as Br₂) concentrations compared were 20,000 ppm, 30,000 ppm, and 40,000 ppm (expressed as Br₂). The solutions were activated separately by adding a stoichiometric amount of 48% HBr and sodium hypochlorite bleach (of known concentration expressed as % Cl₂) to a known amount of city water to theoretically generate the desired concentrations of 20,000 ppm, 30,000 ppm, and 40,000 ppm (expressed as Br₂). The HBr 48% was introduced to the known amount of city water first. Using a magnetic stir plate, the solution was mixed gently until homogenous. While mixing, a stoichiometric amount of sodium hypochlorite bleach of known activity (determined by the iodometric titration) was smoothly added to the solution. Any color transition was noted and the final pH was measured.

The first concentration attempted was 40,000 ppm (expressed as bromine). To activate this solution, city water (741.0 g) was weighed into a liter beaker to which 48% HBr (38.04 g) was added. While mixing, sodium hypochlorite bleach (13.24% expressed as Cl₂) (120.96 g) was smoothly added. This study was terminated after the bleach was added due to the large amounts of toxic bromine gas released from solution and into the atmosphere (fumes visible above surface of the solution). The pH did not go higher than 6.45 and no color transition occurred (final color was dark orange/red, not a bright yellow). The fact that the solution did not turn bright yellow and that the pH did not exceed 7.0 indicated that the HOBr decomposed too quickly to be of practical use, and that it would be too unsafe to store in any facility due to the toxic bromine gas released from solution and into the atmosphere.

The second concentration activated was a 20,000 ppm (expressed as bromine) solution of NaOCl-activated HBr. City water (820.5 g) was weighed into a liter beaker, to which 48% HBr (19.02 g) was added. When the sodium hypochlorite bleach (13.24% expressed as Cl₂), (72.31 g) was added, the color transitioned to dark orange and then back to a bright yellow indicative of activation. No bromine fumes were released, so the decay profile was tracked. The activated solution was stored away from direct UV light to prevent photodegradation during the testing. The test was performed at ambient temperature. The solution was initially tested using the DPD Differentiation Method (also known as the Palin Modification) to confirm no chlorine was present after activation. After proving no excess chlorine was present, the solution was analyzed using the iodometric titration. The results were expressed as ppm as bromine. The results were used to determine the percent bromide activated. Tracking the decay profile of the activated solution followed this.

A graph of ln(Co/Ct) for the 20,000 ppm solution (where Co is the initial concentration of HOBr and Ct is the concentration at time t) was plotted against time t. The plot was close to a straight line (the regression analysis correlation coefficient, R² value was 0.9850). From this line, the half-life and decay rate constant were determined. The half-life was calculated by dividing the slope of the regression line by 0.693—the natural logarithm of 2. The slope of the linear regression line indicated the rate constant for HOBr decomposition.

The third concentration tested was 30,000 ppm as bromine. City water (1039.4 g) was weighed out in a liter beaker, to which 48% HBr (38.02 g) was added. When the sodium hypochlorite bleach (13.07% expressed as Cl₂) (122.54 g) was added the color transitioned to dark orange and then back to a bright yellow and no bromine fumes were released at first. The activated solution was stored away from direct UV light to prevent photodegradation during the stability testing. The test was performed at ambient temperature. The solution was only initially tested using the DPD Differentiation Method (also known as the Palin Modification) to confirm there was no chlorine present after activation. Approximately 1 minute after activating the solution, bromine gas started to be released from the solution as the HOBr decomposed. The sample was tested 0.5 minutes after activation and the activity had already been compromised by the rapid decay of the HOBr, therefore the decay rate was too fast to track the decay profile so half-life and decay rate constant data were unable to be measured. The figures for the three high concentrations are summarized in Table 14 below.

TABLE 14
Summary of Decay Profiles

| NaOCl- | | | | | | |
|---|---|---|---|---|---|---|
| activated | | | | | | |
| HBr Solution | Color | Conc. | pH (After | | Half- | Rate |
| (Theoretical) | Transition | (ppm as Br₂) | Activation) | % Br₂ Activated | Life | Constant |
| 40,000 ppm | Dark | NM | 6.45 | NM | NM | NM |
| as bromine | Orange/Red | | | | | |
| | throughout | | | | | |
| 20,000 ppm | Dark | 18,472 ppm | 6.75 | 92.19% (1 min) | 135 min | 0.0051 min⁻¹ |
| as bromine | Orange to | | | | | |
| | Bright | | | | | |
| | Yellow | | | | | |
| 30,000 ppm | Dark | 22,674 ppm | 6.62 | 75.49% (0.5 min) | NM | NM |
| as bromine | Orange to | | | | | |
| | Bright | | | | | |
| | Yellow | | | | | |

NM = Not measured

In Table 14 above, the time correlating to the highest conversion of bromide ion to HOBr (reported as Br₂) is displayed in parentheses under its respective percent-activated value. Based on the practicality of the concentrations used in this study, the higher boundary was defined as 30,000 ppm as bromine. At this concentration the half-life of the HOBr was too short to be measure, but the conversion of HBr to HOBr was still adequate (75.49%) to engineer around issues connected with controlling the release of bromine fumes into the atmosphere, and allow time for the solution to be diluted to a final use-concentration. Levels of HOBr higher than 40,000 ppm would be would be of little practical value at a meat or poultry plant engaged in sanitizing the animal carcasses, trim and offal because of the inability to measure a meaningful % Br⁻ ion conversion to HOBr due to its rapid decomposition. Poor conversion of bromide ions to HOBr is undesirable as this represents the major chemical cost and hence the economics of the process.

When generating and storing a concentrated solution, similar to the concentrations presented in this example, diluting to the use-concentration is required. To make the concentrated solution to the desired 300 ppm as bromine to spray or soak animal carcasses, trim and offal, the concentrate activated solutions would need to be diluted accordingly. Table 15 provides the dilution factors that would be used to dilute a theoretical 20,000 ppm and 30,000 ppm (expressed as Br₂) activated solution of HBr to give a solution of 300 ppm (expressed as Br₂). These dilutions can be easily produced by either using a pump to deliver the appropriate amount of activated solution to a known flow rate of dilution water, or to use a dosing apparatus similar to that in FIG. 1.

TABLE 15
Dilution Ratio to achieve 300 ppm (expressed as bromine)

| NaOCl-activated HBrSolution | |
|---|---|
| (Theoretical) | Dilution Factors† (w/w) |
| 20,000 ppm as bromine | Dilute by a factor of 62 |
| 30,000 ppm as bromine | Dilute by a factor of 76 |

†The dilution can be accomplished with a proportional dispenser or with a separate diaphragm of centrifugal pump provided the volumetric flow rates of the dilution water and NaOCl-activated solutions are known.

### VI. Method of Reducing Fat, Oil, and Grease

Another embodiment of the invention is a method of reducing the build-up of fat, oil, and grease on food contact and equipment surfaces, and hard surfaces, such as floors, used in the processing of animal carcasses, trim, and offal.

During the processing of animal carcasses, the meat products move between the various processing stations via conveyor belts. Over the course of a shift, layers of fat, oil, and grease can accumulate on the belts, as well as on other equipment, and the floor. On floors these layers represent a slipping hazard to employees whereas on food contact surfaces the layers represent a safe harbor for potentially dangerous microorganisms. Therefore, at the end of a shift, the equipment is chemically cleaned of the layers of fat, oil, and grease to ready it for the next shift. Fat is removed by saponification using highly alkaline chemicals which can be expensive and hazardous. Oil and grease are removed by emulsification with synthetic surfactants.

The antimicrobial solutions prepared by the method of the current invention are near pH neutral, and contain no surfactants. Nevertheless, these solutions have been found to exhibit surprising and remarkable fat, oil, and grease solubilization properties. Not only do these solutions have the advantages of reducing cleaning chemicals and clean-up times, they are also effective against microorganisms concomitant in the fat, oil and grease layers that accumulate on equipment, such as conveyor belts, and other food contact surfaces, and on other hard surfaces, such as floors.

One method of use in a meat or poultry plant during production cycles that would be advantageous would be to use a continuous dip tank or water spray containing the HOBr solution, which would help solubilize and reduce the buildup of fats and oils on conveyor belts and equipment which can harbor pathogenic microorganisms. A second benefit of this method would be to decrease the cleaning time and chemicals used between production shifts due to less contamination and microorganisms remaining on the equipment during production periods.

In order to quantify the lipophilicity of HOBr solutions prepared from NaOCl-activated HBr, the Octanol-Water Partition Coefficient was determined. Further, since the HOBr from DBDMH is closely associated with the organic DMH molecule which contains three carbon atoms, it was expected that these solutions would exhibit even greater lipohilicity for superior fat, oil and grease solubilization properties.

The Octanol-Water Partition Coefficient is defined as:

$${P}_{ow} = \frac{{C}_{octanol}}{{C}_{water}}$$

Where:

P_{ow}=Octanol-Water Partition Coefficient. Commonly the logarithm of this number is reported as Log P_{ow}

C_{octanol}=Concentration of solute in the octanol layer

C_{water}=Concentration of solute in the water layer

### Example 13

A high concentration of a HOBr solution was prepared by introducing sufficient NaOCl to activate 3.34 ml 48% HBr in 900 ml RO water until the pH was 7.23. By iodometric titration, the solution was determined to contain 5625 ppm as Br₂. The slightly yellow activated solution (25 ml) was poured into an Erlenmeyer flask containing octanol (25 ml). This was mixed for two minutes using a high-speed magnetic stirrer after which the two phases were allowed to separate. All of the yellow color had phase-separated into the top octanol layer. Serial dilution followed by use of the DPD total chlorine colorimetric method titration of the aqueous phase revealed it to contain only 59.6 ppm as Br₂. The P_{ow} was calculated to be 1.97. This was repeated for lower concentrations of HOBr by preparing a stock solution of 300 ppm as Br₂ using 0.2 ml 48% HBr in 900 ml RO water and adding sufficient NaOCl bleach until the pH was 7.33. From the 300 ppm as Br₂ stock solution, solutions of 200 and 100 ppm as Br₂ were prepared.

Further octanol-water partition coefficient testing was performed exactly as before. Table 16 summarizes the results.

TABLE 16

| | Concentration in | | | |
|---|---|---|---|---|
| | aqueous phase | | % HOBr | |
| | after partitioning | P_{ow} HOBr | remaining | |
| Concentration | into octanol/ | form NaOCl- | Aqueous | Octanol |
| HOBr (as Br₂) | ppm as Br₂ | activated HBr | Phase | Phase |
| 5625 | 59.6 | 1.970 | 1.06 | 98.94 |
| 300 | 2.59 | 1.976 | 1.05 | 98.95 |
| 200 | 2.59 | 1.911 | 1.21 | 98.79 |
| 100 | 1.46 | 1.871 | 1.33 | 98.67 |

A saturated solution of DBDMH was prepared by slurrying DBDMH (1 g) powder in RO water (99 g) and stirring rapidly for 20 minutes. Undissolved solids were removed by gravity filtration. By iodometric titration, the solution was determined to contain 1170 ppm as Br₂. The DBDMH solution (25 ml) was poured into an Erlenmeyer flask containing octanol (25 ml). This was mixed for two minutes using a high-speed magnetic stirrer after which the two phases were allowed to separate. Serial dilution followed by use of the DPD total chlorine colorimetric method of the aqueous (bottom) phase revealed it to contain only 159.7 ppm as Br₂. The P_{ow} was calculated to be 0.808. The 1170 ppm as Br₂ stock solution was then used to prepare solution of 300, 200 and 100 ppm as Br₂ solutions.

Further octanol-water partition coefficient testing was performed exactly as before. Table 17 summarizes the results.

TABLE 17

| | Concentration in | | | |
|---|---|---|---|---|
| | aqueous phase | | % HOBr | |
| | after partitioning | P_{ow} HOBr | remaining | |
| Concentration | into octanol/ | from | Aqueous | Octanol |
| HOBr (as Br₂) | ppm as Br₂ | DBDMH | Phase | Phase |
| 1170 | 157.5 | 0.808 | 13.46 | 86.54 |
| 300 | 50.74 | 0.731 | 15.66 | 84.34 |
| 200 | 34.99 | 0.719 | 16.03 | 83.97 |
| 100 | 19.125 | 0.645 | 18.48 | 81.52 |

Comparing the data in Table 16 with that in Table 17 indicates that the HOBr from NaOCl-activated HBr exhibits far more lipophilicity than the HOBr from DBDMH. This is a surprising discovery because the HOBr from DBDMH is closely associated with the organic DMH molecule, which contains five carbon atoms and would be expected to partition into the organic octanol phase to a greater extent than the HOBr from the totally inorganic NaOCl and HBr sources. Thus, the enhanced lipophilicity of HOBr from NaOCl/HBr compared to HOBr from DBDMH affords the former with remarkably superior fat, oil and grease solubilization properties in meat and poultry processing environments.

### Example 14

The stability of the HOBr from NaOCl-activated HBr source that partitioned into the octanol phase was determined.

A stock solution of HOBr was prepared by adding 48% HBr (3.45 ml) to RO water (900 ml). Industrial-grade sodium hypochlorite (about 20 ml) was added until the pH of the solution was 7.26. Iodometric titration revealed the HOBr solution to be 3487 ppm as Br₂. This solution was designated the high concentration of HOBr. An aliquot (42 g) of this solution was made up to 500 ml with RO water. This solution was designated the low concentration of HOBr.

To each of the above solutions (200 ml), octanol (200 ml) was added. The aqueous and the non-aqueous layers were vigorously mixed with a magnetic stirrer whereupon the layers were allowed to phase separate. The stability of the HOBr that had partitioned into the octanol phase was assessed using a non-aqueous iodometric titration. In this technique, an aliquot of the respective octanol phases was added to an aqueous phase containing acetic acid and potassium iodide. With intense mixing of the two phases, using the oxidation of iodide to iodine as the driving force to partition the HOBr out of the octanol and into the aqueous phase, the mixture was slowly titrated with 0.100 N sodium thiosulfate as a 1% starch solution was introduced to sharpen the blue-to-clear end-point.

Non-aqueous iodometric titrations were performed for each solution of HOBr partitioned into octanol. The results are summarized in Table 18.

TABLE 18

| | High Concentration of | Low Concentration of |
|---|---|---|
| | HOBr in Octanol/ | HOBr in Octanol/ppm as |
| Time/min | ppm as Br₂ | Br₂ |
| 0 | 3541 | 384 |
| 30 | 1402 | 172 |
| 60 | 1030 | 92 |
| 90 | 800 | 85 |
| 170 | 469 | 0 |

It can be seen that for both high and low concentration of octanol-partitioned HOBr, the HOBr is unstable and decomposes over the course of 170 minutes. The HOBr is evidently decomposing due to its oxidation of the hydroxyl group of octanol. Similar oxidation reactions would occur when HOBr partitions into fats, oils and greases in meat and poultry processing environments. This explains the remarkable fat, oil, and grease solubilization properties that solutions of HOBr from NaOCl-activated HBr have been discovered to possess.

### VII. Methods and Compositions Employing Alkali Metal Bromides

Experimental Methods

Halogen levels were measured using N,N-diethyl-p-phenylenediamine (DPD) spectrophotometric methods. For selective determination of activated bromine, the glycine modification of the method was employed. This required adding 2 ml of a 10% glycine solution to 98 ml of test solution followed by use of the DPD-free chlorine indicator reagent. The glycine binds any chlorine present as N-chloroglycine so that the DPD-free chlorine indicator reagent response was solely due to the presence of bromine in the sample. Addition of a few crystals of potassium iodide to the test vial released any glycine-bound chlorine so that the new DPD response was due to the sum of the halogen species present.

Activation in a Residence Tank or Pipe Containing City Water

### Example 15

Sodium bromide and sodium hypochlorite were independently proportioned to a sample of city water from Modesto, Calif. to make a concentrate of 1000 ppm HOBr/OBr⁻ (expressed as Br₂). The laboratory simulation of this method of activation was accomplished by introducing a 1:1 mole ratio of sodium bromide and sodium hypochlorite bleach to the city water for dilution. The activated solutions were then monitored for the next 2 to 2.5 hours to assess the time it took for the maximum bromine concentration to be attained, the percent conversion of Br⁻ ion to HOBr/OBr⁻, the percent of total halogen recovered, and the stability of the activated solutions.

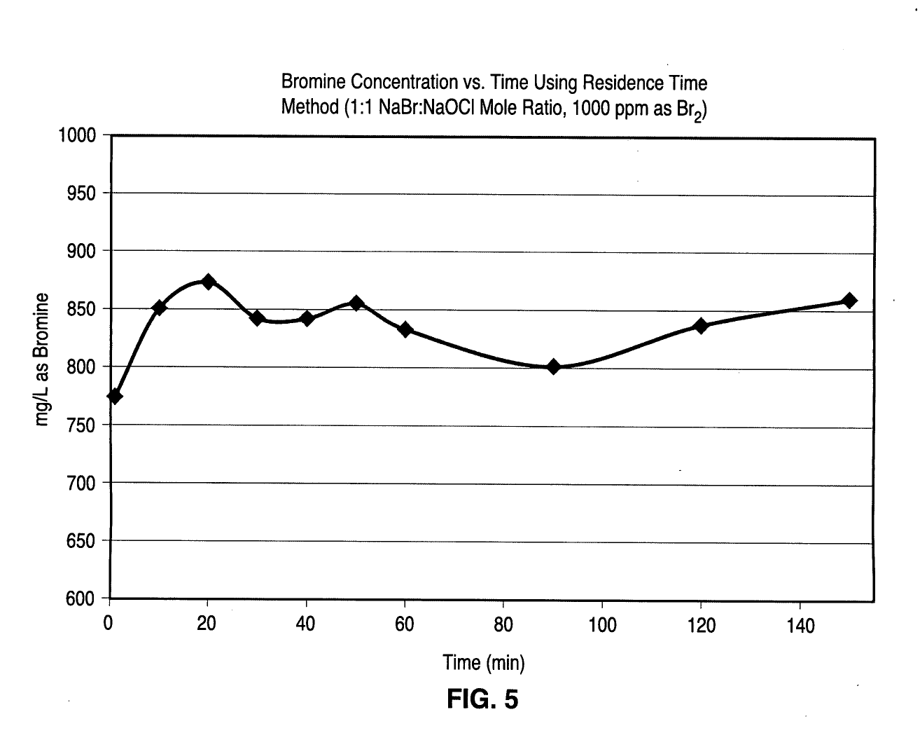

FIG. 5 shows the actual ppm of HOBr/OBr⁻ (expressed as Br₂) obtained over time when attempting to make a theoretical 1000 ppm activated solution by adding stoichiometric amounts of NaBr and NaOCl to the city water. It can be seen that the maximum bromine concentration was attained at 880 ppm at about 18 minutes, demonstrating that the maximum biocidal benefit is not achieved until after that time. The bromine concentration remained fairly constant for the next 132 minutes, indicating that the activated solution remained stable over that period of time. The pH of the activated 1000 ppm HOBr/OBr⁻ (expressed as Br₂) solution was 9.57.

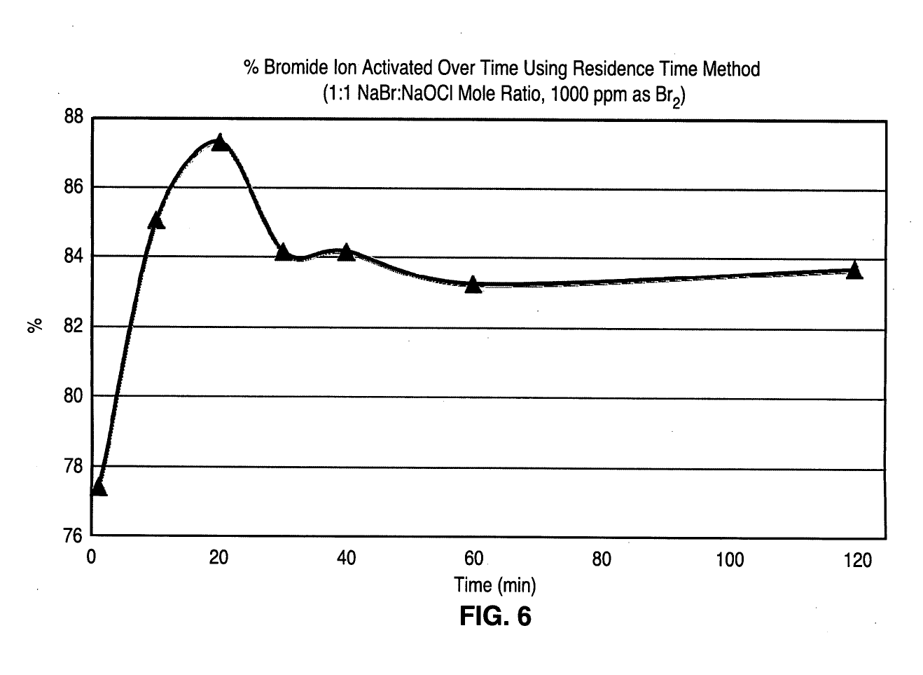

FIG. 6 plots the percent Br⁻ ion activated to HOBr/OBr⁻ over the same time period. Only 77% of the Br⁻ ion was activated immediately. However, after 18 minutes almost 88% of the Br⁻ ion was activated, demonstrating an efficient utilization of the Br⁻ ion.

### Example 16

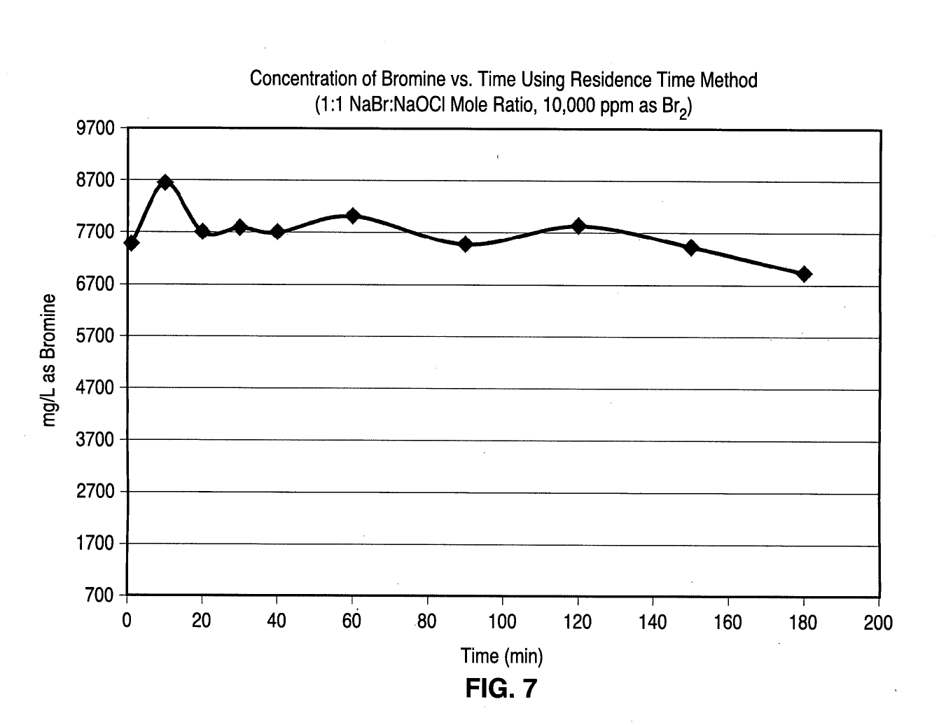

When the experiment of Example 15 was repeated to make a theoretical 10,000 ppm HOBr/OBr⁻ solution (expressed as Br₂), the maximum bromine concentration was attained at 8700 ppm at about 10 minutes, demonstrating that the maximum biocidal benefit is not achieved until after that time. This is depicted in FIG. 7. The bromine concentration in the activated solution remained fairly constant over the next 170 minutes, indicating that the activated solution remained stable over that period of time.

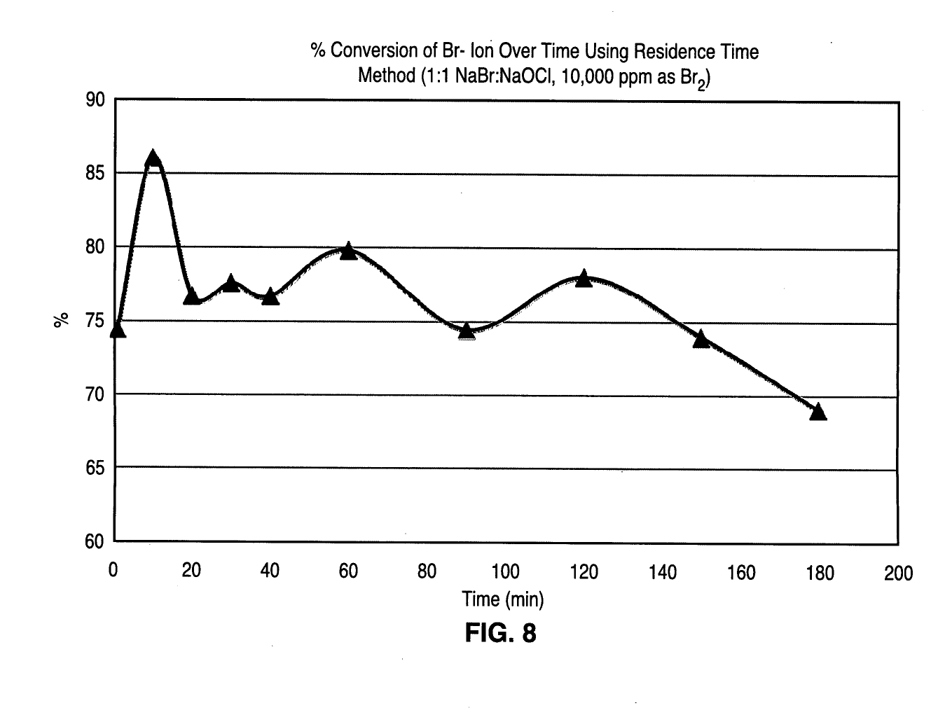

FIG. 8 plots the percent Br⁻ ion activated to HOBr/OBr⁻ over the same time period. Only 75% of the Br⁻ ion was activated immediately. However, after 10 minutes, about 85% of the Br⁻ ion was activated, demonstrating an efficient utilization of the Br⁻ ion. The pH of the activated 10,000 ppm HOBr/OBr⁻ (as expressed Br₂) solution was 10.81.

The data in Examples 15 and 16 show the surprising stability of the 1000 and 10,000 ppm HOBr/OBr⁻ (expressed as Br₂) activated solutions. Contrary to the teachings of the prior art, the activated solutions are not so unstable that they must be introduced to the receiving water immediately before use, but rather are of sufficient stability that they can be prepared, stored, and used later as needed. The receiving water may be industrial cooling water that is treated with sufficient activated solution to continuously dose the water to about 0.1 ppm (expressed as Br₂). The receiving water may also be water used to wash meat and poultry carcasses, trim, and offal that is treated with sufficient activated solution to dose the water to between 200-900 ppm (expressed as Br₂). Finally, the receiving water may be water that is treated with sufficient activated solution to dose it to 500 ppm (expressed as Br₂) and used to clean and sanitize food contact hard surfaces and equipment.

Users who employ the method of activation described in Examples 1 and 2 may experience frequent CaCO₃ scaling problems either in the residence tank or in pipework leading to the water to be treated. The use of NaOCl bleach will increase the pH of the city water used to make the activated solutions. The pH was measured at 9.57 for the 1000 ppm HOBr/OBr⁻ (expressed as Br₂) solution in Example 15 and 10.81 for the 10,000 ppm HOBr/OBr⁻ (expressed as Br₂) solution in Example 16. Under practical conditions, high levels of calcium in the city water will likely precipitate as CaCO₃, which will accumulate on surfaces, clog pipework, and lead to costly downtime for removal or replacement.

Activation by Direct Combination of Sodium Bromide and Sodium Hypochlorite Solutions

### Example 17

This method avoids the use of dilution water (and hence scaling problems). This method involves introducing neat, concentrated solutions of sodium bromide and sodium hypochlorite into the opposite ends of a tee fitting, and then piping the combined mixture into the cooling water to be treated.

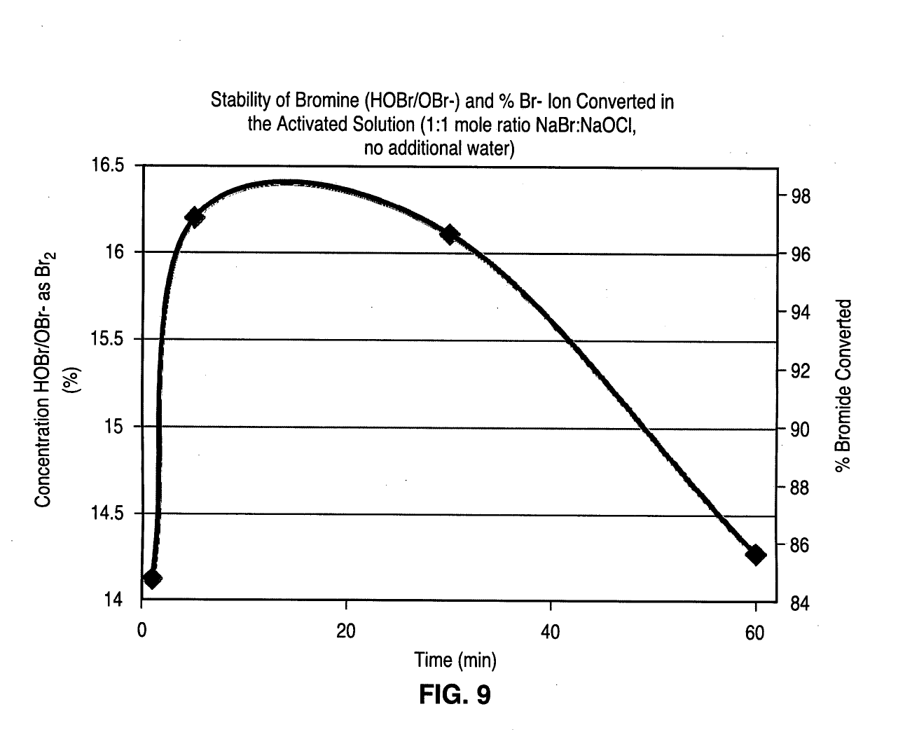

A mixture containing a 1:1 mole ratio of NaBr and NaOCl was prepared by adding 20.02 g of aqueous 40% NaBr to 54.30 g NaOCl (10.66% expressed as Cl₂) solution. No additional water was used. The mixture turned yellow, indicating that bromine had been generated. The pH of the NaBr/NaOCl mixture was measured to be 12.86. Then the amount of HOBr/OBr⁻ generated in the mixture was measured by weighing a small portion (0.08 g) into 20 L of synthetic cooling water of pH 8.8, followed by using the glycine modification of the DPD colorimetric method previously described. The stability of the HOBr/OBr⁻ in the activated solution was then tracked over the course of an hour. FIG. 9 charts the HOBr/OBr⁻ content (expressed as Br₂) and the concentration of the activated solution (left hand y-axis). The same curve also defines the percent activation of Br⁻ ion into HOBr/OBr⁻ (right hand y-axis). It can be seen that about 84% of the Br⁻ ion was immediately activated. This maximized between 10 and 15 minutes where 97% of the Br⁻ ion was in the form of HOBr/OBr⁻. It can also be seen that the concentration of the activated solution was not maximized until about 5 minutes, and remained stable until about 30 minutes. The concentration of the activated solution started to drop after about 30 minutes.

FIG. 9 shows that the mixture prepared with a 1:1 mole ratio of NaBr and NaOCl displayed surprising stability between about 5 and 30 minutes. Contrary to the teachings of the prior art, this activated solution does not need to be introduced to the receiving waters immediately, but is of sufficient stability that it may be prepared in advance, stored, and used as required. This feature allows the user sufficient time to build an inventory of activated solution so that the inventory may be dosed to several different water systems requiring treatment.

The receiving water may be industrial cooling water that is treated with sufficient activated solution to continuously dose the water to about 0.1 ppm (expressed as Br₂). The receiving water may also be water used to wash meat and poultry carcasses, trim, and offal that is treated with sufficient activated solution to dose the water to about 200-900 ppm (expressed as Br₂). Finally, the receiving water may be treated with sufficient activated solution to dose it to about 450 ppm (expressed as Br₂) and used to clean and sanitize food contact hard surfaces and equipment.

### Example 18

To demonstrate the utility of the activated solution for typical cooling water, a small amount was introduced to a synthetic cooling water prepared with the water quality characteristics shown in Table 19.

TABLE 19

| | |
|---|---|
| pH | 8.8 |
| Calcium hardness (mg/L as | 200 |
| CaCO₃) | |
| Total alkalinity (mg/L as CaCO₃) | 150 |
| Conductivity/μScm⁻¹ (adjusted | >2500 |
| with NaCl) | |

To obtain a theoretical dose of 2.0 ppm HOBr/OBr⁻ (expressed as Br₂), the mixture (0.404 g) was immediately introduced to 20 L of synthetic cooling water in a five-gallon pail that was stirred with an overhead mixer.

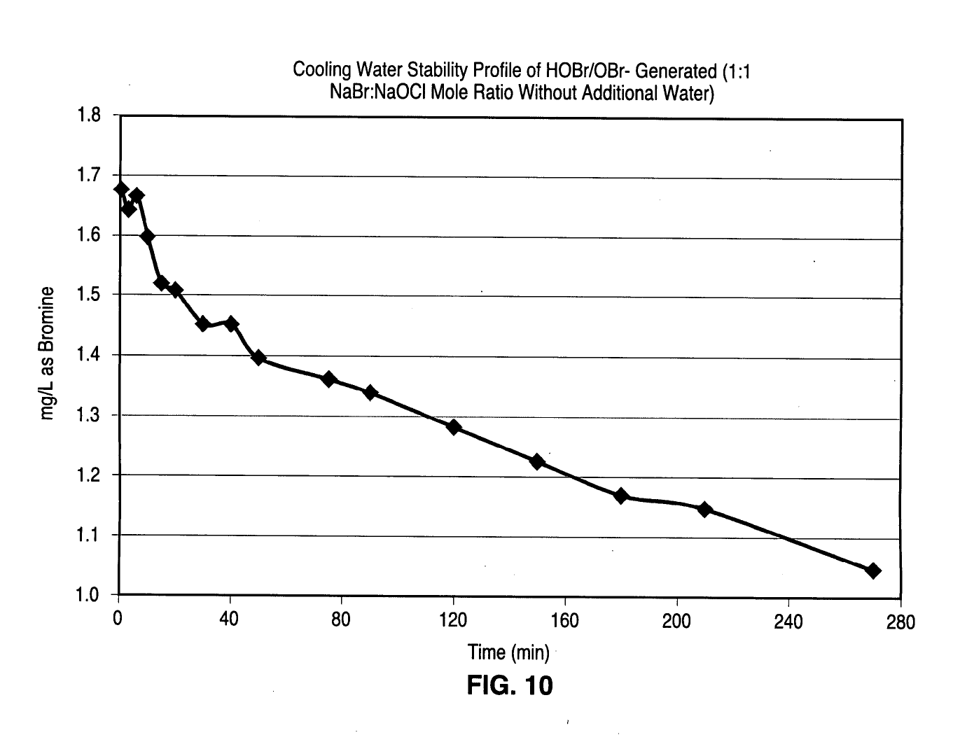

The ambient temperature treated cooling water was immediately subjected to DPD analysis to determine the same efficiency parameters as before. Because 1.7 ppm of HOBr/OBr⁻ (expressed as Br₂) was immediately recovered, only 85% of the Br⁻ ion was immediately activated. However, as FIG. 10 shows, the HOBr/OBr⁻ in the cooling water was not particularly stable and decomposed to just 1.06 ppm of HOBr/OBr⁻ (expressed as Br₂) after 4.5 hours, corresponding to a 53% conversion of the initial bromide. This degradation profile is shown in FIG. 10.

### Example 19

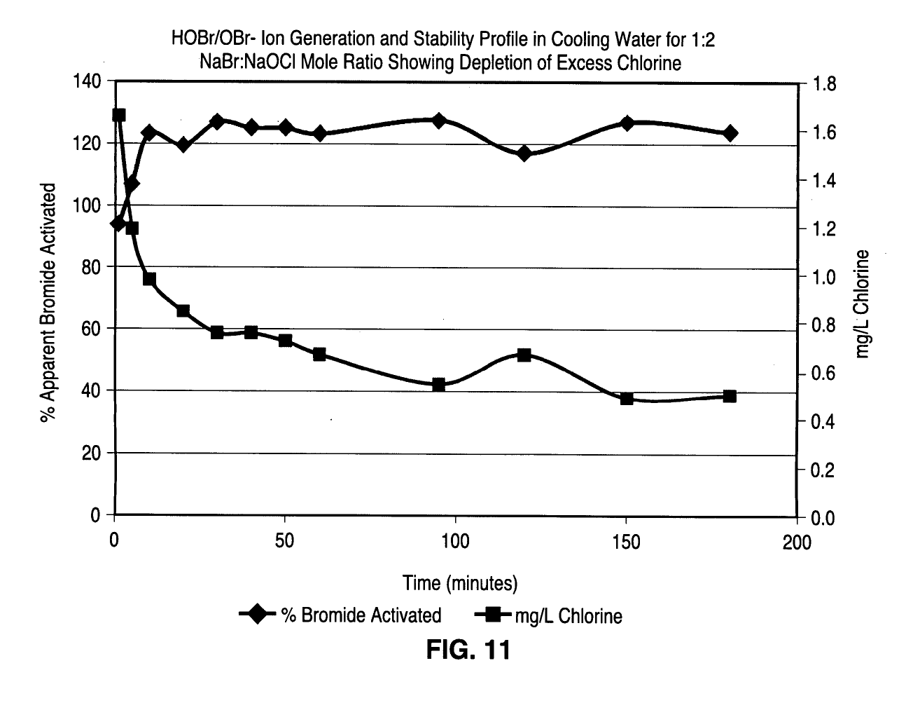

Many users employ more than a 1:1 mole ratio of NaBr to NaOCl in the belief that in the bulk recirculating cooling water the excess NaOCl reactivates the Br⁻ ion that is the degradation product of HOBr/OBr⁻. This was investigated in another experiment in which the mole ratio of NaBr to NaOCl was increased to 1:2 and the cooling water was dosed with sufficient mixture to achieve a theoretical 4 ppm of HOBr/OBr⁻ (expressed as Br₂). FIG. 11 plots the HOBr/OBr⁻ generation and stability profile over a three-hour period.

It can be seen for the 1:2 NaBr:NaOCl mole ratio that the HOBr/OBr⁻ appears to be far more stable than for the 1:1 mole ratio as seen in FIG. 10. However, the trend can be explained by the data in FIG. 11 which plots the percent “apparent” Br⁻ ion activated to HOBR/OBr⁻ and the depletion of the excess chlorine over the same time period. At the higher NaBr:NaOCl mole ratio the percent conversion of Br⁻ ion is over 93% within one minute of the activated solution being introduced to the cooling water. The depletion of the excess chlorine mirrors the regeneration of HOBr/OBr⁻ as the percent “apparent” Br⁻ ion conversion increases to 124%. The appearance that the stability of HOBr/OBr⁻ is improved at the higher NaBr:NaOCl mole ratio is simply due to the fact that the excess NaOCl is reactivating the Br⁻ ion degradation product.

The utility of activated solutions prepared with NaBr:NaOCl mole ratios of up to 1:2 to treat water that is used to wash meat and poultry carcasses, trim, and offal for the reduction of pathogenic microorganisms is demonstrated by the following example.

### Example 20

The efficacy of an activated solution of HOBr/OBr⁻ ion was investigated against a culture of pathogenic microorganisms that had been sprayed onto pieces of meat.

A stock solution of E. coli O157:H7 (ATCC 35150) was incubated at 35° C. for two days in Sigma Nutrient Broth for microbial culture. One daily transfer of the inoculum was made to ensure a sufficient concentration of E. coli O157:H7 was available for the study. The broth and bacteria mixture were then centrifuged leaving the E. coli O157:H7 to be re-suspended in approximately 500 mL Butterfield's buffer. The E. coli buffer solution was serially diluted and plated on 3M Petrifilm E. coli plates. The plates were incubated at 35° C. for 24 hours, at which point it was determined that the E. coli O157:H7 population was 6.0×10⁷ or log₁₀ 7.78.

The lean beef used in this study was boneless top sirloin. The meat was cut into six equal pieces that averaged a weight of 78.4 g. Each beef piece was evenly sprayed with the E. coli Butterfield's solution and allowed to soak.

An activated solution of HOBr/OBr⁻ was prepared using a 1:1 mole ratio of NaBr:NaOCl in the absence of dilution water. Thus, 40% NaBr (20.06 g) was added to NaOCl bleach (12.94% as Cl₂) (42.73 g). Iodometric titration of the mixture revealed it to have a halogen content of 19.84% as Br₂ and it had a pH of 12.18. Two minutes were allowed to pass in order to maximize the activation of Br⁻ into HOBr/OBr⁻. Then the sample was shielded from light with a cover and then set aside and stored for 15 minutes.

After 15 minutes, the activated solution of HOBr/OBr⁻ (4.54 g) was added to city water (1000 mL) of pH 7.8. Analysis using the modified DPD method indicated that it contained 918 ppm of HOBr/OBr⁻ expressed as Br₂ and that chlorine was absent. Due to the high pH of the activated HOBr/OBr⁻ solution, the city water to which it was added now had a pH of 9.93. In order to lower the pH to be more like the pH of city water, 32% hydrochloric acid (HCl) (0.59 g) was introduced to give a solution with a pH of 7.86.

Four of the E. coli O157:H7 inoculated cuts of boneless top sirloin were then evenly sprayed with the 918 ppm as Br₂ test solution and allowed to sit for 15 minutes. At the same time, as a control, two of the E. coli O157:H7 inoculated cuts were sprayed with city water that had not been treated with activated HOBr/OBr⁻.

After 15 minutes contact time, each piece of beef was placed in a sterile poultry rinse bag containing 100 g of city water. Each bag was held closed and then vigorously tumbled for one minute in order to dislodge viable surface-associated E. coli bacteria into the aqueous phase. This water was then sampled and plated onto 3M Petrifilm E. coli plates. All plating was completed within 30 minutes of spraying the pieces of beef with the activated HOBr/OBr⁻. The plates were then incubated at 35° C. for 24 hours, after which the plates were enumerated.

Table 20 reports the average number of viable surface-associated E. coli O157:H7 bacteria dislodged from the beef pieces into the tumble water.

TABLE 20
Enumeration Results of Microbiological Analysis (E. coli O157:H7)

| | | Log₁₀ Reduction |
|---|---|---|
| Description | Log₁₀ (CFU/mL) | (% Reduction) |
| Control | 5.66 | N/A |
| Acidified, | 4.85 | 0.81 |
| activated HOBr/OBr⁻ | | (84.5%) |
| solution (918 ppm Br₂) | | |

It can be seen that the untreated city water control averaged a log₁₀ of 5.66 E. coli O157:H7, while the acidified activated HOBr/OBr⁻ treated beef pieces averaged a log₁₀ of 4.85 E. coli O157:H7. The log₁₀ reduction in E. coli O157:H7 bacteria using the acidified HOBr/OBr⁻ solution was 0.81 CFU/mL corresponding to a reduction of 84.5%.

Despite being sprayed with a high concentration (918 ppm as Br₂) of acidified, activated HOBr/OBr⁻ solution, none of the beef pieces exhibited any sign of bleaching or discoloration.

The invention has been described above with the reference to the preferred embodiments. Those skilled in the art may envision other embodiments and variations of the invention that fall within the scope of the claims.

We claim:

1. A method of introducing a biocidally effective dose of hypobromous acid and hypobromite ion into water used to wash meat and poultry carcasses, trim, and offal for the reduction of pathogenic microorganisms, comprising:
(a) Mixing a solution of a source of bromide ion with a solution of a source of hypochlorite ion to activate the bromide ion and to form a solution selected from the group consisting of hypobromous acid, hypobromite ion, and a mixture of both hypobromous acid and hypobromite ion;
(b) Allowing sufficient time to maximize the activation of said bromide ion into said solution selected from the group consisting of hypobromous acid, hypobromite ion, and a mixture of both hypobromous acid and hypobromite ion;
(c) Storing said solution selected from the group consisting of hypobromous acid, hypobromite ion, and a mixture of both hypobromous acid and hypobromite ion for subsequent use; and
(d) Introducing said stored solution to water used to wash meat and poultry carcasses, trim, and offal for the reduction of pathogenic microorganisms.

2. A method of introducing a biocidally effective dose of hypobromous acid and hypobromite ion into industrial cooling water for the reduction of pathogenic microorganisms, comprising:
(a) Mixing a solution of a source of bromide ion with a solution of a source of hypochlorite ion to activate the bromide ion and to form a solution selected from the group consisting of hypobromous acid, hypobromite ion, and a mixture of both hypobromous acid and hypobromite ion;
(b) Allowing sufficient time to maximize the activation of said bromide ion into said solution selected from the group consisting of hypobromous acid, hypobromite ion, and a mixture of both hypobromous acid and hypobromite ion;
(c) Storing said solution selected from the group consisting of hypobromous acid, hypobromite ion, and a mixture of both hypobromous acid and hypobromite ion for subsequent use; and
(d) Introducing said stored solution to industrial cooling water for the reduction of pathogenic microorganisms.

3. A method of introducing a biocidally effective dose of hypobromous acid and hypobromite ion into water used to reduce pathogenic microorganisms on food contact hard surfaces and equipment, comprising:
(a) Mixing a solution of a source of bromide ion with a solution of a source of hypochlorite ion to activate the bromide ion and to form a solution selected from the group consisting of hypobromous acid, hypobromite ion, and a mixture of both hypobromous acid and hypobromite ion;
(b) Allowing sufficient time to maximize the activation of said bromide ion into said solution selected from the group consisting of hypobromous acid, hypobromite ion, and a mixture of both hypobromous acid and hypobromite ion;
(c) Storing said solution selected from the group consisting of hypobromous acid, hypobromite ion, and a mixture of both hypobromous acid and hypobromite ion for subsequent use; and
(d) Introducing said stored solution to water used to reduce pathogenic microorganisms on food contact hard surfaces and equipment.

4. The method of claim 1, wherein said solution of a source of bromide ion is sodium bromide solution.

5. The method of claim 1, wherein said solution of a source of hypochlorite ion is sodium hypochlorite solution.

6. The method of claim 1, wherein the mole ratio of the source of bromide ion to the source of hypochlorite ion is between 1:1 and 1:2.

7. The method of claim 1, wherein up to 18 minutes is allowed to maximize the activation of said bromide ion.

8. The method of claim 1, wherein said storing is for a period of time up to three hours.

9. The method of claim 1, wherein said stored solution is stable for up to three hours.

10. The method of claim 1, further comprising introducing additional water in step (a).

11. The method of claim 1, further comprising, after step (d), lowering the pH of said water used to wash meat and poultry carcasses, trim, and offal.

12. The method of claim 3, further comprising, after step (d), lowering the pH of said water used to treat food contact hard surfaces and equipment.
